(19) United States
(12) Patent Application Publication
(10) Pub. No.: US 2019/0005732 A1
(43) Pub. Date: Jan. 3, 2019

(54) PROGRAM FOR PROVIDING VIRTUAL SPACE WITH HEAD MOUNT DISPLAY, AND METHOD AND INFORMATION PROCESSING APPARATUS FOR EXECUTING THE PROGRAM

(71) Applicant: COLOPL, Inc., Tokyo (JP)

(72) Inventor: Seiji SATAKE, Tokyo (JP)

(21) Appl. No.: 16/022,810

(22) Filed: Jun. 29, 2018

(30) Foreign Application Priority Data
Jun. 30, 2017 (JP) 2017-129088

(51) Int. Cl. G06T 19/00; G02B 27/01; G06T 7/20; G06T 7/70; G06K 9/00; H04N 21/488; G10L 15/26

(52) U.S. Cl. CPC G06T 19/006; G02B 27/0172; G06T 7/20; G02B 2027/0138; G06K 9/00288; H04N 21/4882; G10L 15/26; G06T 7/70

(57) ABSTRACT

A method includes defining a first virtual space comprising a first avatar and a virtual viewpoint. The method includes detecting in a real space a motion of a part of a body of the first user. The method further includes controlling the first avatar in the virtual space in response to the detected motion of the part of the body. The method includes arranging a camera object in the first field of view, wherein the camera object defines a second field of view comprising at least a portion of the first avatar. The method includes detecting whether a photography event has occurred in the virtual space. The method includes notifying, in response to the occurrence of the photography event, the first user that a photographed image corresponding to the second field of view is to be generated. The method includes generating the photographed image after the notification.

### RELATED APPLICATIONS

The present application claims priority to Japanese Application No. 2017-129088, filed on Jun. 30, 2017, the disclosure of which is hereby incorporated by reference herein in its entirety.

### TECHNICAL FIELD

This disclosure relates to photography processing in a virtual space, and more particularly, to a technology for controlling photography timing.

### BACKGROUND

A technology for providing a virtual space (virtual reality space) by using a head-mounted device (HMD) is known. There have been proposed various technologies for enriching an experience of a user in the virtual space.

For example, in Japanese Patent Application Laid-open No. 2003-141563 (Patent Document 1), there is described a technology for forming an alter-ego (avatar) of oneself in a virtual space by “extracting facial feature points required for individual identification from photographed information obtained by photographing a head of a subject from two directions, namely, from the front and the side, recreating a three-dimensional structure of each facial part such as a head skeletal structure, a nose, a mouth, eyebrows, and eyes based on the facial feature points, and integrating the facial parts to recreate a three-dimensional shape of the face”.

In Non-Patent Document 1, there is described a technology for photographing an avatar arranged in a virtual space by a virtual camera.

### Patent Document

[Patent Document 1] JP 2003-141563 A

### Non-Patent Document

[Non-Patent Document 1] “Oculus demos a VR Selfie Stick and Avatar” [online], [retrieved on Jun. 8, 2017], Internet (URL: http://jp.techcrunch.com/2016/04/14/20160413vr-selfie-stick/)

### SUMMARY

According to at least one embodiment of the present invention, there is provided a method of providing a virtual space. The method includes defining a first virtual space including a first avatar and a virtual viewpoint, the first avatar being associated with a first user and the first user is associated with a first head-mounted device (HMD). The method further includes detecting a motion of the first HMD. The method further includes defining a first field of view from the virtual viewpoint in the virtual space in accordance with the motion of the first HMD. The method further includes generating a field-of-view image corresponding to the first field of view. The method further includes displaying the field-of-view image on the first HMD. The method further includes detecting in a real space a motion of a part of a body of the first user. The method further includes controlling the first avatar in accordance with the motion of the part of the body. The method further includes arranging a camera object in the first field of view. The method further includes defining a second field of view from the camera object in the virtual space, the second field of view including at least a part of the first avatar. The method further includes detecting that a photography event has occurred in the virtual space. The method further includes notifying, in accordance with the occurrence of the photography event, the first user that a photographed image corresponding to the second field of view is to be generated. The method further includes generating the photographed image after the notification is issued.

The above-mentioned and other objects, features, aspects, and advantages of at least one embodiment of the disclosure may be made clear from the following detailed description of this disclosure, which is to be understood in association with the attached drawings.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of the computer according to at least one embodiment of this disclosure.

FIG. 15 A diagram of a technical concept according to at least one embodiment of this disclosure.

FIG. 16 A diagram of control for detecting a mouth from a facial image of the user according to at least one embodiment of this disclosure.

FIG. 17 A diagram of processing of detecting a shape of the mouth by a tracking module according to at least one embodiment of this disclosure.

FIG. 18 A diagram of processing of detecting the shape of the mouth by the tracking module according to at least one embodiment of this disclosure.

FIG. 19 A table of a face tracking data structure according to at least one embodiment of this disclosure.

FIG. 20 A diagram of a hardware configuration and a module configuration of the server according to at least one embodiment of this disclosure.

FIG. 21 A diagram of a field-of-view image displayed on a monitor according to at least one embodiment of this disclosure.

FIG. 22 A flowchart of automatic photography processing based on sound according to at least one embodiment of this disclosure.

FIG. 23 A table of a data structure of an automatic photography DB according to at least one embodiment of this disclosure.

FIG. 24 A diagram of processing of arranging a camera object according to at least one embodiment of this disclosure.

FIG. 25 A diagram of a field-of-view image displayed on the monitor under the state of FIG. 24 according to at least one embodiment of this disclosure.

FIG. 26A A diagram of facial feature points acquired when the user has a neutral facial expression according to at least one embodiment of this disclosure.

FIG. 26B A diagram of facial feature points acquired when the user is surprised according to at least one embodiment of this disclosure.

FIG. 27 A flowchart of automatic photography processing based on face tracking data according to at least one embodiment of this disclosure.

FIG. 28 A diagram of how the user actively performs photography in the virtual space according to at least one embodiment of this disclosure.

FIG. 29 A table of a data structure of a photography DB according to at least one embodiment of this disclosure.

FIG. 30 A table of a data structure of a viewpoint history DB according to at least one embodiment of this disclosure.

FIG. 31 A panorama image for describing automatic photography processing based on viewpoint history according to at least one embodiment of this disclosure.

FIG. 32 A table of a data structure of a comment DB according to at least one embodiment of this disclosure.

FIG. 33 A schematic flowchart of processing in which the server detects a photography timing according to at least one embodiment of this disclosure.

FIG. 34 A table of a data structure of a user according to at least one embodiment of this disclosure.

FIG. 35 A diagram of processing of generating an image including an avatar object of another user according to at least one embodiment of this disclosure.

FIG. 36 A flowchart of processing of automatically generating an image including another avatar object under a state in which the processor is communicating to/from another computer according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

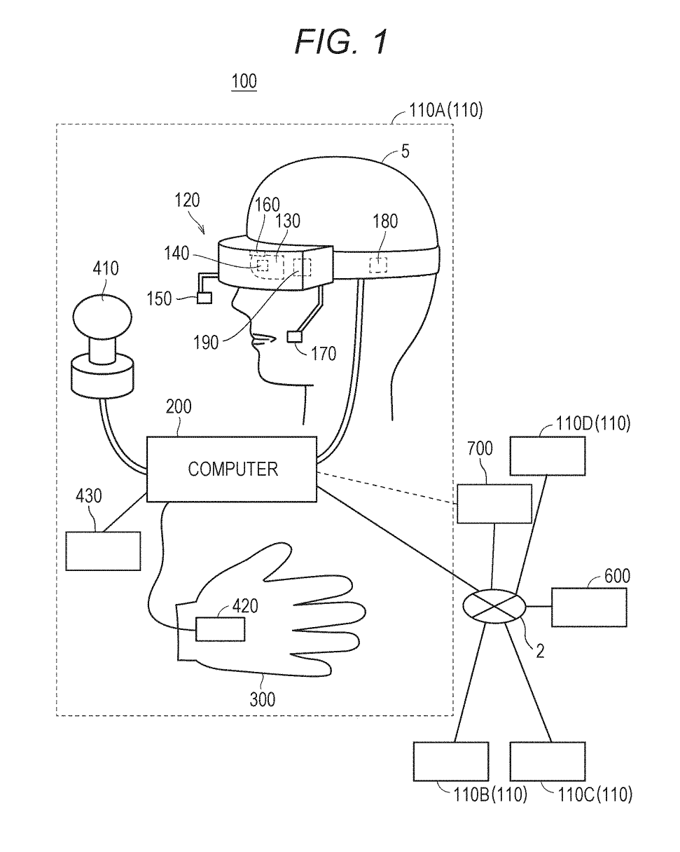

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smart glasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

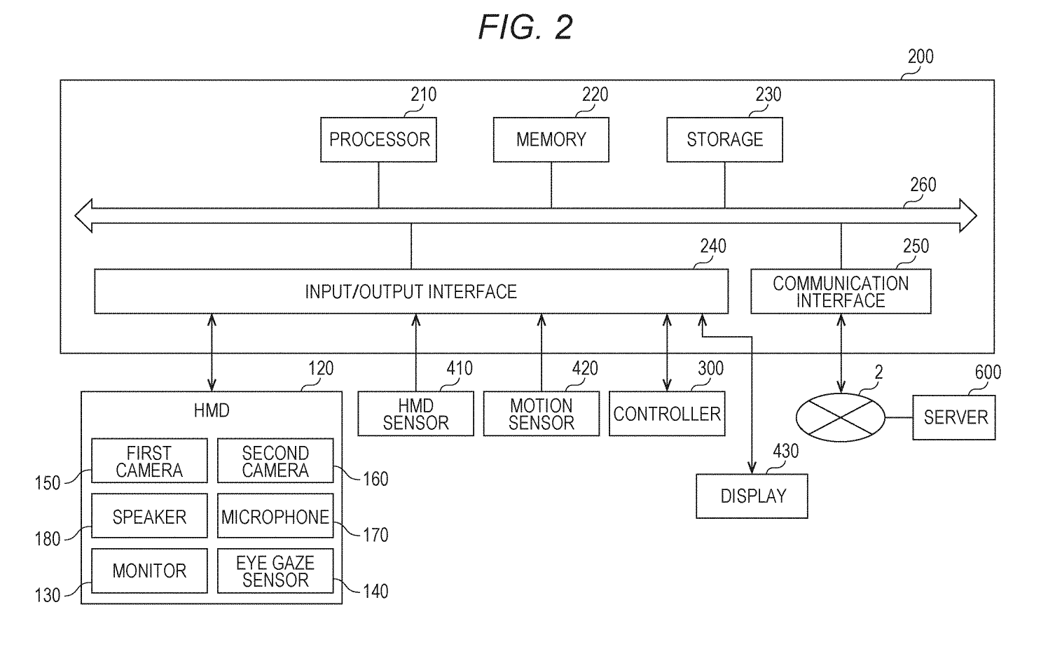

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-field Coordinate System]

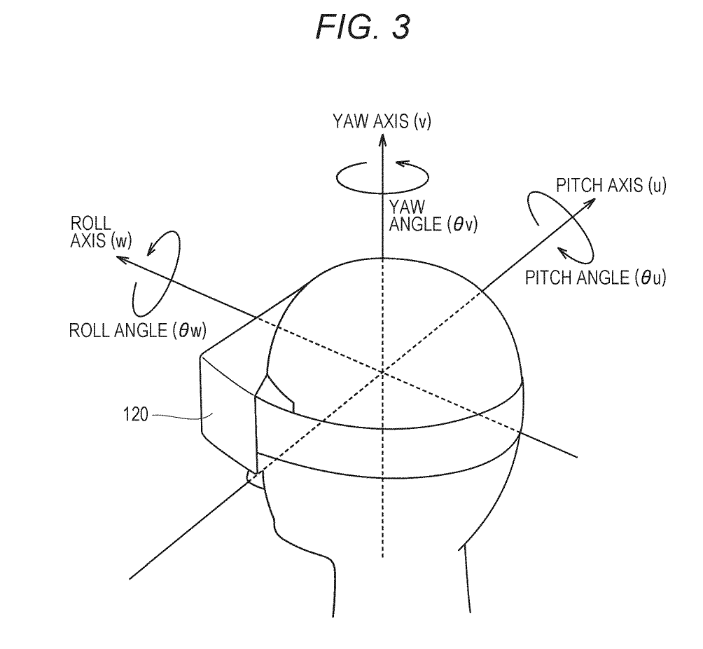

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

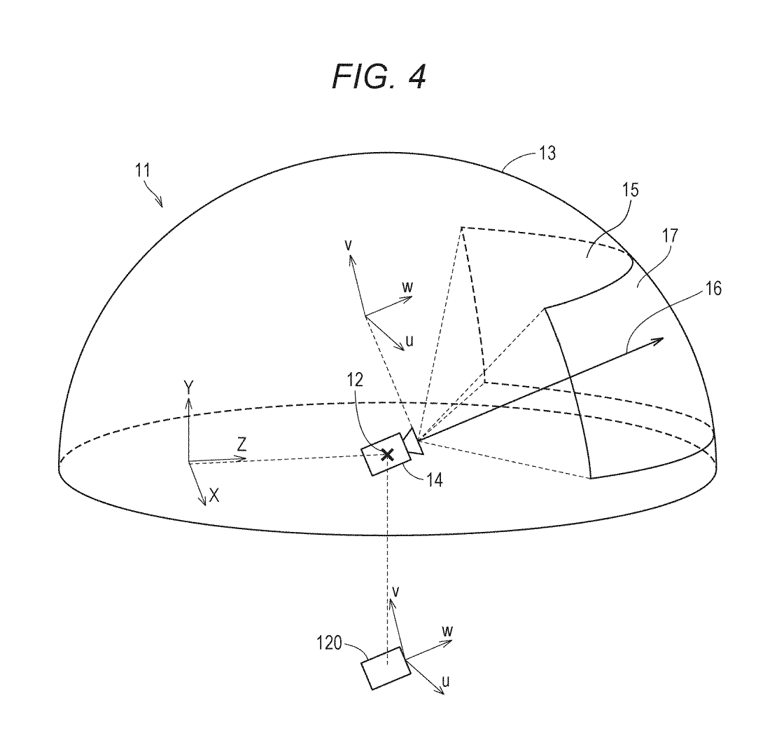

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

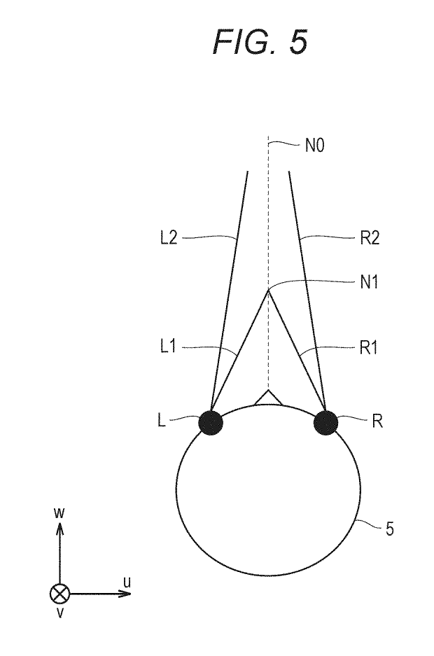

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight NO corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

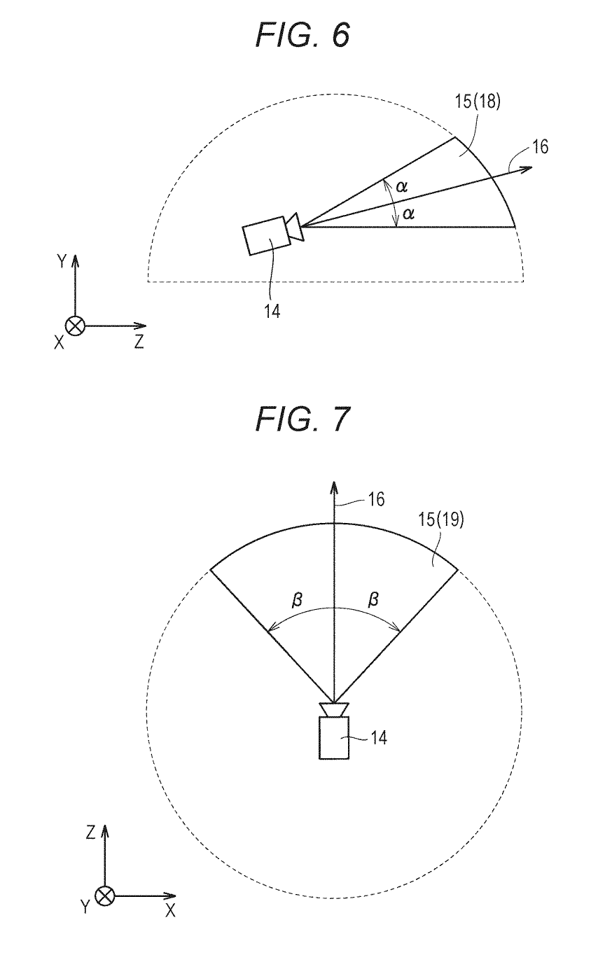

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to apart of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

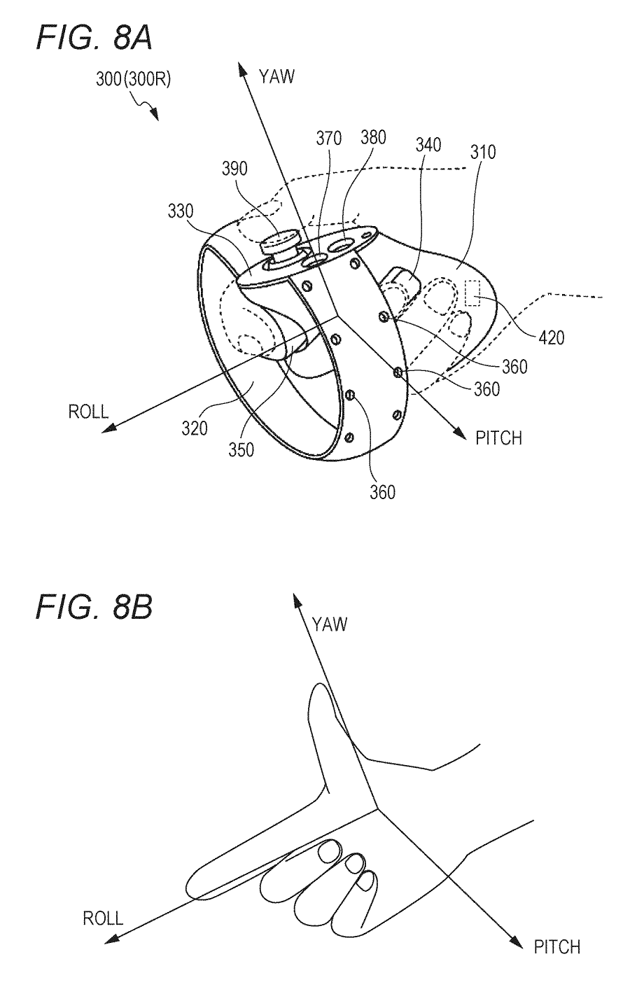

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

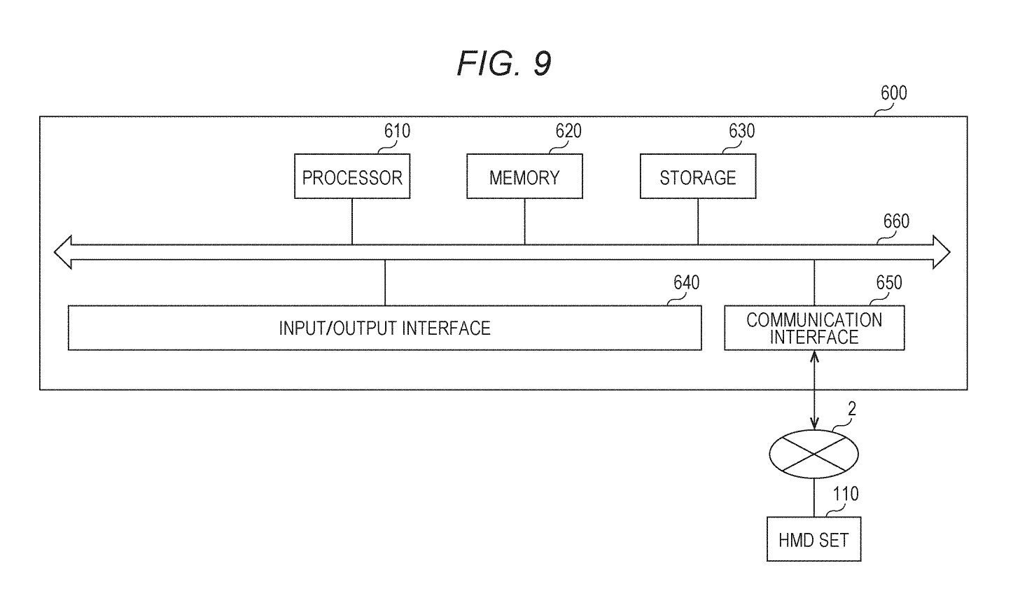

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

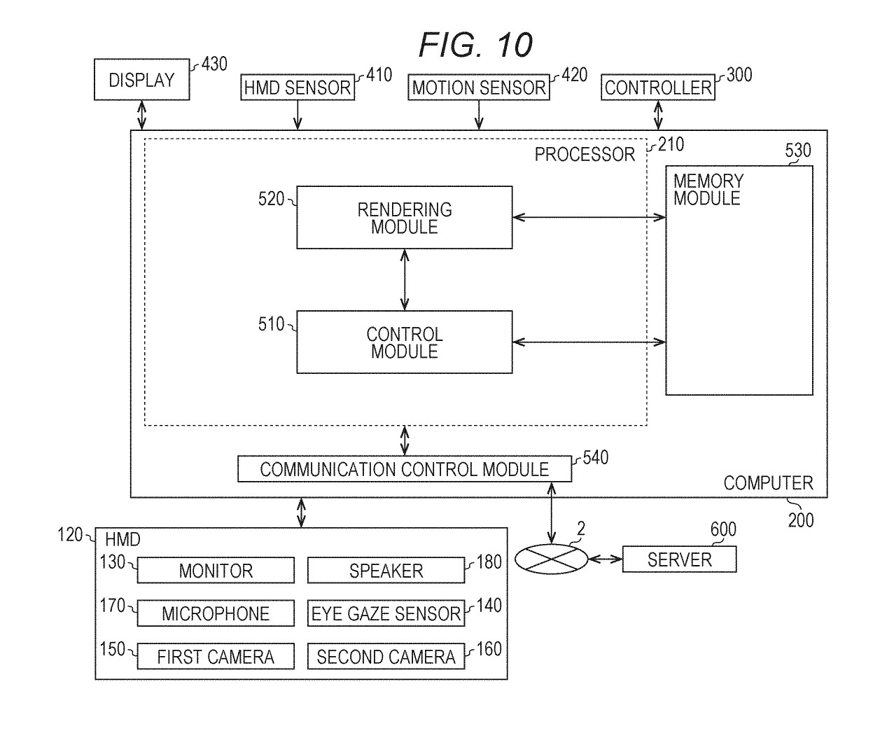

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

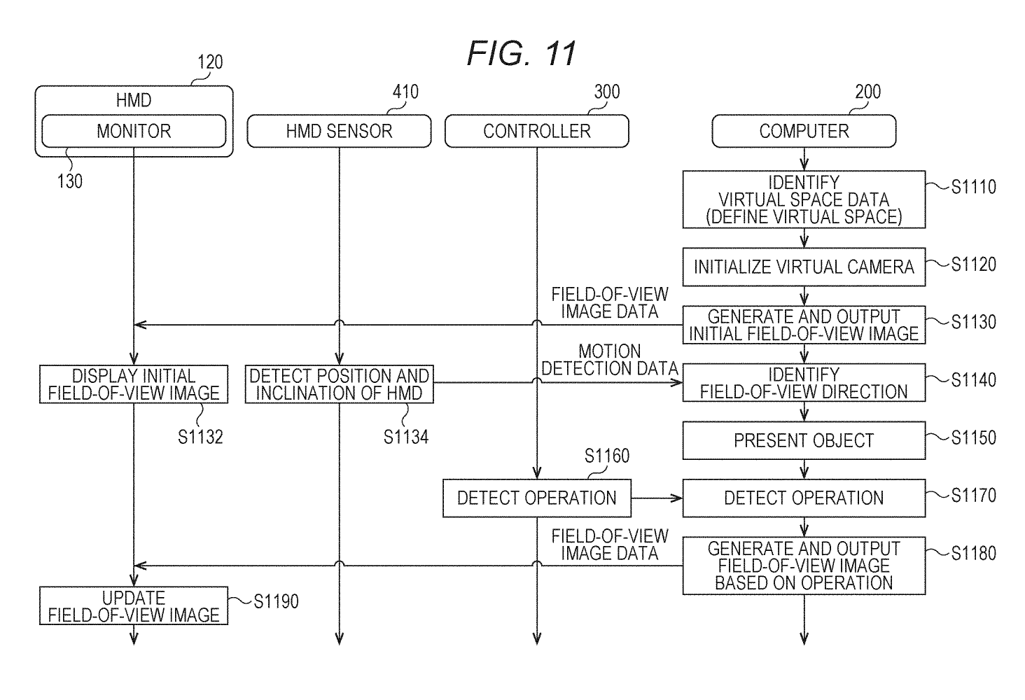

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

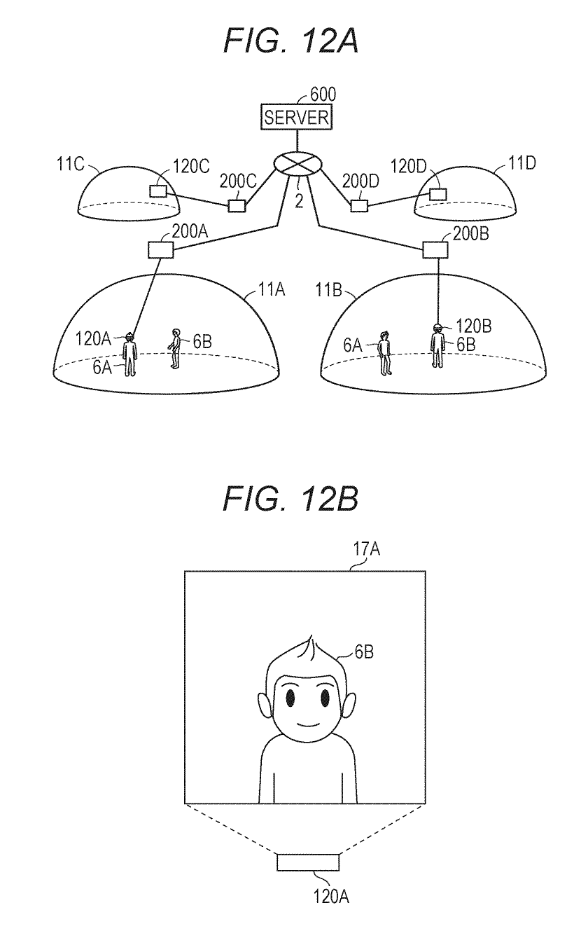

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

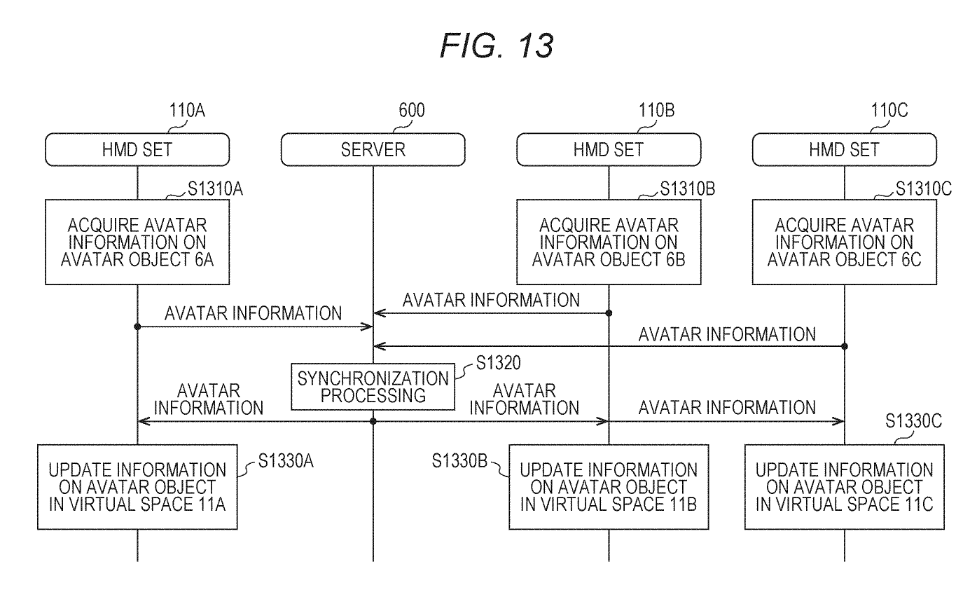

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Configuration of Modules]

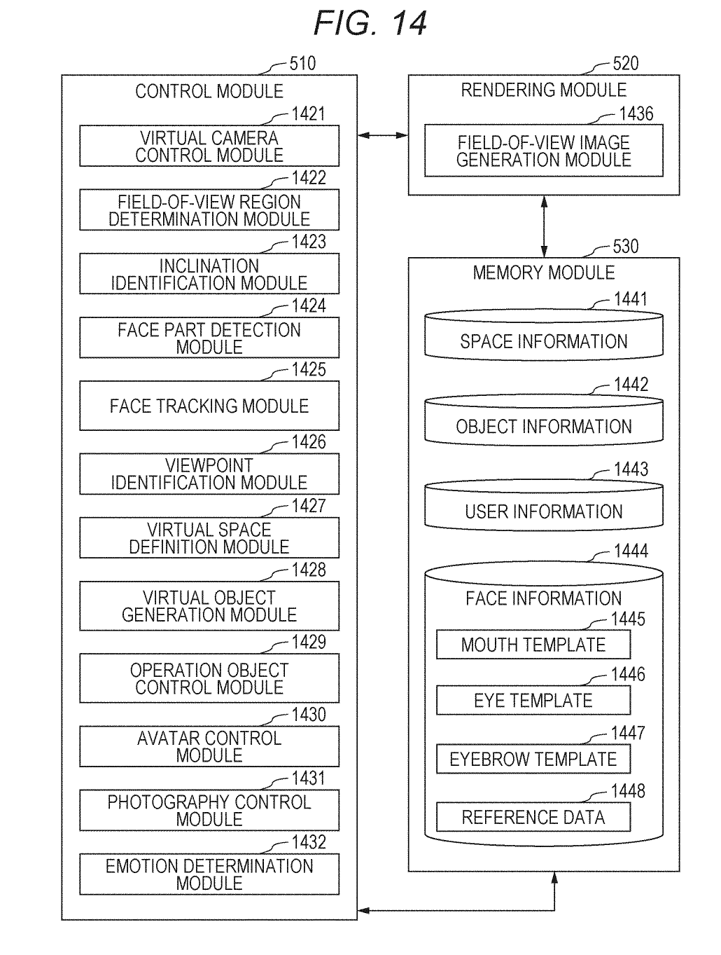

With reference to FIG. 14, a module configuration of the computer 200 is described. FIG. 14 is a block diagram of a configuration of modules of the computer 200 according to at least one embodiment of this disclosure.

In FIG. 14, the control module 510 includes a virtual camera control module 1421, a field-of-view region determination module 1422, an inclination identification module 1423, a face part detection module 1424, a tracking module 1425, a viewpoint identification module 1426, a virtual space definition module 1427, a virtual object generation module 1428, an operation object control module 1429, an avatar control module 1430, a photography control module 1431, and an emotion determination module 1432. The rendering module 520 includes a field-of-view image generation module 1436. The memory module 530 stores space information 1441, object information 1442, user information 1443, and face information 1444.

In at least one aspect, the control module 510 controls an image displayed on the monitor 130 of the HMD 120.

The virtual camera control module 1421 arranges the virtual camera 14 in the virtual space 11. The virtual camera control module 1421 controls a position of the virtual camera 14 in the virtual space 11 and the inclination (photography direction) of the virtual camera 14. The field-of-view region determination module 1422 determines the field-of-view region 15 based on the inclination of the HMD 120 and the position of the virtual camera 14. The field-of-view image generation module 1436 generates the field-of-view image 17 to be displayed on the monitor 130 based on the determined field-of-view region 15.

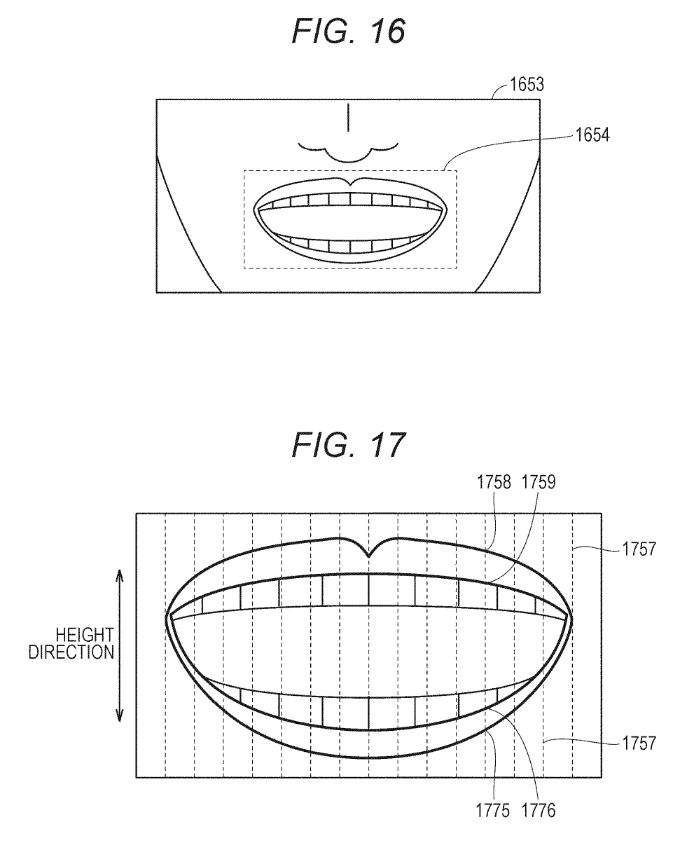

The inclination identification module 1423 identifies the inclination of the HMD 120 based on output of the HMD sensor 410. In at least one aspect, the inclination identification module 1423 identifies the inclination of the HMD 120 based on output of the sensor 140 functioning as a motion sensor. The face part detection module 1424 detects parts (e.g., mouth, eyes, and eyebrows) forming the face of the user 5 from a facial image of the user 5 generated by the first camera 150 and the second camera 160. The tracking module 1425 intermittently detects the feature points (position) of each face part detected by the face part detection module 1424. In other words, the tracking module 1425 detects the facial expression of the user 5. The details of control by the face part detection module 1424 and the tracking module 1425 are described later with reference to FIG. 16 to FIG. 18.

The viewpoint identification module 1426 detects a line of sight of the user 5 in the virtual space 11 based on a signal from the eye gaze sensor 140. Next, the viewpoint identification module 1426 detects a point-of-view position (coordinate values in the XYZ coordinate system) at which the detected line of sight of the user 5 and the celestial sphere of the virtual space 11 intersect with each other. More specifically, the viewpoint identification module 1426 detects the viewpoint position by converting the line of sight of the user 5 defined in the uvw coordinate system into the XYZ coordinate system based on the position and inclination of the virtual camera 14.

The control module 510 controls the virtual space 11 provided to the user 5. The virtual space definition module 1427 defines the size and shape of the virtual space 11. The virtual space definition module 1427 develops a panorama image 13 in the virtual space 11.

The virtual object generation module 1428 generates an object to be arranged in the virtual space 11 based on the object information 1442 to be described later. The object may include a tree, an animal, a person, and the like.

The operation object control module 1429 arranges in the virtual space 11 an operation object for receiving an operation of the user 5 in the virtual space 11. The user 5 operates the operation object to operate, for example, an object arranged in the virtual space 11. In at least one aspect, the operation object includes, for example, a hand object corresponding to the hand of the user 5. In at least one aspect, the operation object control module 1429 moves the hand object in the virtual space 11 so that the hand object moves in association with a motion of the hand of the user 5 in the real space based on output of the motion sensor 420. In at least one aspect, the operation object corresponds to a hand part of an avatar object described later.

The avatar control module 1430 generates data for arranging an avatar object of the user 5 of another computer 200, which is connected via the network 2, in the virtual space 11. In at least one aspect, the avatar control module 1430 generates data for arranging an avatar object of the user 5 in the virtual space 11. In at least one aspect, the avatar control module 1430 generates an avatar object simulating the user 5 based on an image containing the user 5. In at least one aspect, the avatar control module 1430 generates data for arranging in the virtual space 11 an avatar object that is selected from among a plurality of types of avatar objects (e.g., objects simulating animals or objects of deformed humans).

The avatar control module 1430 translates the motion of the HMD 120 detected by the HMD sensor 410 in the avatar object. For example, the avatar control module 1430 detects that the HMD 120 has been inclined, and generates data for arranging the avatar object in an inclined manner. In at least one aspect, the avatar control module 1430 translates a motion of the controller 300 in a hand (operation object) of an avatar object. In this case, the controller 300 includes, for example, a motion sensor, an acceleration sensor, or a plurality of light emitting elements (e.g., infrared LEDs) for detecting a motion of the controller 300. The avatar control module 1430 translates the facial expression of the user 5 detected by the tracking module 1425 in the face of an avatar object arranged in the virtual space 11.

The photography control module 1431 controls photography by a camera object 1551 described later. For example, the photography control module 1431 controls the timing of arranging the camera object 1551, and the position and direction of the camera object 1551. The photography control module 1431 generates an image corresponding to a photography range 1552 of the camera object 1551 and stores the generated image in the storage 230.

The emotion determination module 1432 determines an emotion of the user 5. In at least one aspect, the emotion determination module 1432 determines the emotion of the user 5 based on a sound signal of the user 5 input from the microphone 170. In at least one aspect, the emotion determination module 1432 determines the emotion of the user 5 based on the facial expression of the user 5 detected by the tracking module 1425.

When one object arranged in the virtual space 11 collides with another object in the virtual space 11, the control module 510 detects the collision. The control module 510 detects, for example, a timing at which an object and another object have touched with each other, and performs predetermined processing in response to the detected timing. The control module 510 performs predetermined processing when the control module 510 detects a timing at which an object and another object, which have been in contact with each other, have moved away from each other.

The memory module 530 stores the space information 1441, the object information 1442, the user information 1443, and the face information 1444.

The space information 1441 includes one or more templates defined in order to provide the virtual space 11. The virtual space definition module 1427 defines the virtual space 11 in accordance with those one or more templates. The space information 1441 further includes a plurality of panorama images 13 to be developed in the virtual space 11. The panorama image 13 may include a still image and a moving image. The panorama image 13 may include an image in the real space and an image in a non-real space (e.g., computer graphics).

The object information 1442 includes data for generating an object (e.g., camera object 1551) to be arranged in the virtual space 11.

The user information 1443 contains a user ID for identifying the user 5. The user ID may be, for example, an internet protocol (IP) address or a media access control (MAC) address set to the computer 200 used by the user. In at least one aspect, the user ID is set by the user. The user information 1443 contains, for example, a program for causing the computer 200 to function as the control device of the HMD system 100.

The face information 1444 contains templates that are stored in advance for the face part detection module 1424 to detect face parts of the user 5. In at least one embodiment, the face information 1444 contains a mouth template 1445, an eye template 1446, and an eyebrow template 1447. Each template may be an image corresponding to a part forming the face. For example, the mouth template 1445 may be an image of a mouth. Each template may include a plurality of images. The face information 1444 further contains reference data 1448. The reference data 1448 is data detected by the tracking module 1425 under a state in which the user 5 has a neutral facial expression.

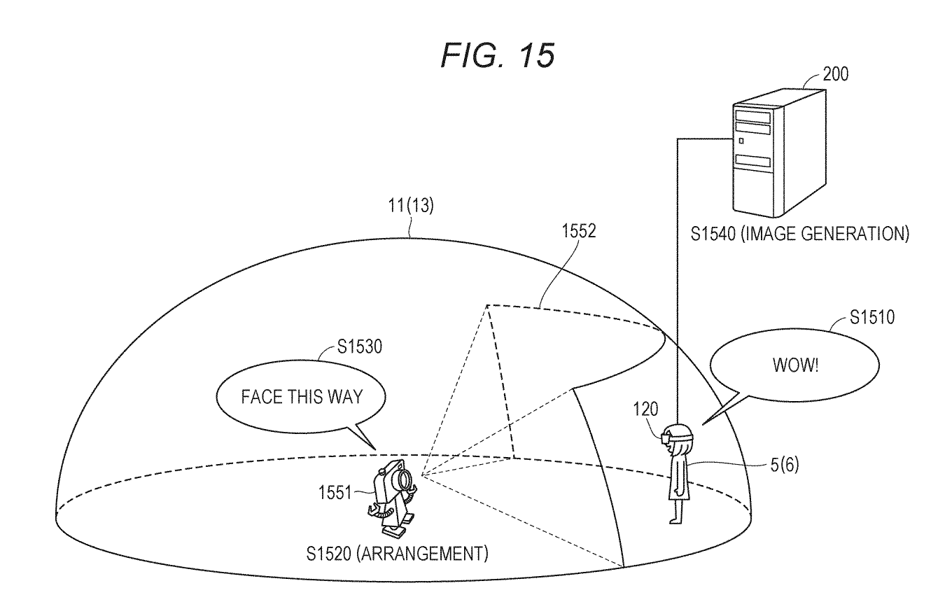

FIG. 15 is a diagram of a technical concept according to at least one embodiment of this disclosure. With reference to FIG. 15, the computer 200 provides the virtual space 11 to the HMD (head-mounted device) 120 worn by the user 5. The computer 200 develops the panorama image 13 in the virtual space 11. In FIG. 15, the panorama image 13 is a moving image.

The computer 200 arranges the avatar object 6 corresponding to the user 5 in the virtual space 11. The computer 200 further displays on the monitor of the HMD 120 an image corresponding to the field-of-view region of the avatar object 6. As a result, the user 5 is able to visually recognize the panorama image 13. The computer 200 arranges in the virtual space 11 the camera object 1551 having a photography function.

The computer 200 detects a timing suitable for photography (hereinafter also referred to as “photography timing”). The computer 200 notifies the user 5 of the photography timing and the position of the camera object 1551. After issuing the notification, the computer 200 generates an image corresponding to a photography range 1552 of the camera object 1551 (executes photography by camera object 1551).

An outline of the processing in which the computer 200 detects the photography timing is now described. In at least one embodiment, the user 5 sees the panorama image 13 and is impressed. The computer 200 detects that the user 5 is impressed based on (a sound signal corresponding to) an utterance of the user 5 or the facial expression of the face of the user 5. The computer 200 detects the timing at which the user 5 has become impressed as the photography timing.

In at least one embodiment, the computer 200 detects the photography timing based on history information on the panorama image 13 of another user different from the user 5. The history information contains information on which portion of the panorama image 13 has often been viewed by other users, which part of the panorama image 13 has often been photographed by other users, and the like.

As at least one example, automatic photography processing based on the sound signal corresponding to the utterance of the user 5 is described. With reference to FIG. 15, the user 5 is impressed with the panorama image 13 and utters “Wow”. The computer 200 receives input of the sound signal corresponding to the utterance of the user 5 from the microphone provided in the HMD 120.

In at least one embodiment, the computer 200 extracts a character string from the sound signal. The computer 200 detects the photography timing based on the extracted character string containing an exclamation (e.g., from a list of words determined in advance). The computer 200 arranges the camera object 1551 in the virtual space 11 based on the detection of photography timing. At this time, the computer 200 arranges the camera object 1551 such that at least a part (e.g., head) of the avatar object 6 is included in the photography range 1552 of the camera object 1551.

In at least one embodiment, the computer 200 notifies the user 5 of the position of the camera object 1551 and that the photography timing has arrived. For example, the computer 200 notifies the user 5 of the position of the camera object 1551 by arranging the camera object 1551 on the monitor (field of view of the user 5) of the HMD 120. The computer 200 notifies the user 5 of the photography timing by outputting a sound (in FIG. 15, “Face this way”) from the speaker provided in the HMD 120. This processing causes the user 5 to look at the camera object 1551. As a result, the avatar object 6 corresponding to the user 5 faces the direction of the camera object 1551.

In at least one embodiment, the computer 200 executes photography by the camera object 1551, and generates an image corresponding to the photography range 1552 of the camera object 1551. As a result, the computer 200 automatically generates an image including the avatar object 6 looking at the camera at the timing suitable for photography.

With the processing described above, the user 5 is able to obtain an image (e.g., image looking at the camera) photographed at the photography timing without actively performing a photography operation. In this way, the computer 200 can enrich the virtual experience of the user 5 in the virtual space 11. A specific configuration and control for implementing such processing is now described.

[Face Tracking]

At least one example of detecting a facial expression (motion of face) of the user is now described with reference to FIG. 16 to FIG. 18. In FIG. 16 to FIG. 18, at least one example of detecting a motion of the mouth of the user 5 is described. The detection method described with reference to FIG. 16 to FIG. 18 is not limited to a motion of the mouth of the user, and may be applied to detection of motions of other parts (e.g., eyes, eyebrows, nose, and cheeks) forming the face of the user 5.

FIG. 16 is a diagram of control for detecting a mouth from a facial image 1653 of the user according to at least one embodiment of this disclosure. The facial image 1653 generated by the first camera 150 includes the nose and mouth of the user 5.

The face part detection module 1424 identifies a mouth region 1654 from the facial image 1653 by pattern matching using the mouth template 1444 stored in the face information 1444. In at least one aspect, the face part detection module 1424 sets a rectangular comparison region in the facial image 1653, and calculates a similarity degree between an image of the comparison region and an image of the mouth template 1435 while changing the size, position, and angle of this comparison region. The face part detection module 1424 may identify, as the mouth region 1654, a comparison region for which a similarity degree larger than a threshold value determined in advance is calculated.

The face part detection module 1424 may further determine whether the comparison region corresponds to the mouth region based on a relative relationship between the position of the comparison region for which the calculated similarity degree is larger than the threshold value and positions of other face parts (e.g., eyes and nose).

The tracking module 1425 detects a more detailed shape of the mouth from the mouth region 1654 detected by the face part detection module 1424.

FIG. 17 is a diagram of processing of detecting the shape of the mouth by the tracking module 1425 according to at least one embodiment of this disclosure. Referring to FIG. 17, the tracking module 1425 sets a contour detection line 1757 for detecting the shape of the mouth (contour of lips) contained in the mouth region 1654. A plurality of contour detection lines 1757 are set at intervals determined in advance in a direction orthogonal to a height direction of the face.

The tracking module 1425 may detect a change in brightness value of the mouth region 1654 along each of the plurality of contour detection lines 1757, and identify a position at which the change in brightness value is abrupt as a contour point. More specifically, the tracking module 1425 may identify, as the contour point, a pixel for which a brightness difference (namely, change in brightness value) between the pixel and an adjacent pixel is equal to or more than a threshold value determined in advance. The brightness value of a pixel is obtained by, for example, integrating RBG values of the pixel with predetermined weighting.

The tracking module 1425 identifies two types of contour points from the image corresponding to the mouth region 1654. The tracking module 1425 identifies a contour point 1758 corresponding to a contour of the outer side of the mouth (lips) and a contour point 1759 corresponding to a contour of the inner side of the mouth (lips). In at least one aspect, when three or more contour points are detected on one contour detection line 1757, the tracking module 1425 identifies contour points on both ends of the contour detection line 1757 as the outer contour points 1758. In this case, the tracking module 1425 may identify contour points other than the outer contour points 1758 as the inner contour points 1759. When two or less contour points are detected on one contour detection line 1757, the tracking module 1425 may identify the detected contour points as the outer contour points 1758.

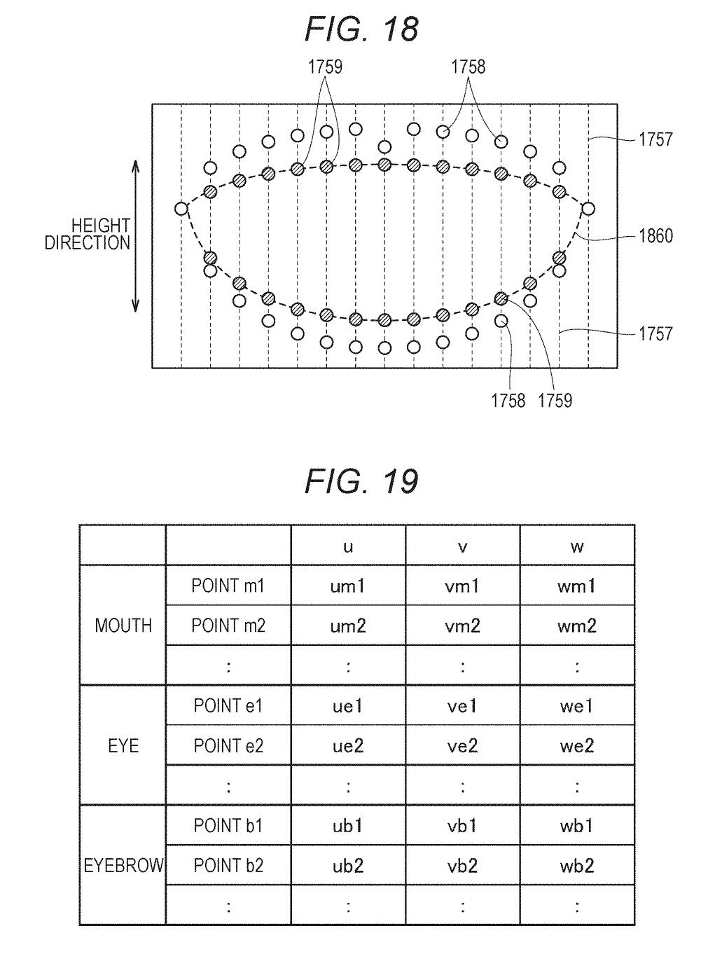

FIG. 18 is a diagram of processing of detecting the shape of the mouth by the tracking module 1425 according to at least one embodiment of this disclosure. In FIG. 18, the outer contour points 1758 and the inner contour points 1759 are indicated by white circles and hatched circles, respectively.

The tracking module 1425 interpolates points between the inner contour points 1759 to identify a mouth shape 1860. In this case, the contour points 1759 can be said to be feature points of the mouth. In at least one aspect, the tracking module 1425 identifies the mouth shape 1860 using a nonlinear interpolation method, for example, spline interpolation. In at least one aspect, the tracking module 1425 identifies the mouth shape 1860 by interpolating points between the outer contour points 1758. In at least one aspect, the tracking module 1425 identifies the mouth shape 1860 by removing contour points that greatly deviate from an assumed mouth shape (predetermined shape that may be formed by upper lip and lower lip of person) and using the contour points that remain. In this manner, the tracking module 1425 may identify a motion (shape) of the mouth of the user. The method of detecting the mouth shape 1860 is not limited to the above-mentioned method, and the tracking module 1425 may detect the mouth shape 1860 with another method. The tracking module 1425 may detect motions of the eyes and eyebrows of the user in the same manner. The tracking module 1425 may be capable of detecting the shape of parts such as the cheeks and the nose.

FIG. 19 is a table of a face tracking data structure according to at least one embodiment of this disclosure. The face tracking data represents position coordinates in the uvw visual field coordinate system of the plurality of feature points forming the shape of each part. In at least one example, points m1, m2 . . . shown in FIG. 19 correspond to the inner contour points 1759 forming the mouth shape 1860. In at least one aspect, the face tracking data is coordinate values in the uvw visual field coordinate system with the position of the first camera 150 set as a reference (origin). In at least one aspect, the face tracking data is coordinate values in a coordinate system with a feature point determined in advance for each part set as a reference (origin). In at least one example, the points m1, m2 . . . are coordinate values in a coordinate system with any one of the feature points corresponding to the corner of the mouth from among the inner contour points 1759 as the origin.

The computer 200 transmits the generated face tracking data to the server 600. The server 600 transfers this data to another computer 200 that communicates to/from the computer 200. The other computer 200 translates the received face tracking data in the avatar object corresponding to the user of the receiving computer 200.

In FIG. 12B, the computer 200A receives face tracking data representing the facial expression of the user 5B from the computer 200B. The computer 200A translates the received data in the avatar object 6B. In at least one example, at several of the vertices of the polygons forming the avatar object 6B, the vertices corresponding to the face tracking data are set. The computer 200A moves the positions of the corresponding vertices based on the face tracking data, to thereby translate the facial expression of the user 5B in the avatar object 6B. As a result, the user 5A can recognize the facial expression of the user 5B via the avatar object 6B.

[Control Structure of Server 600]

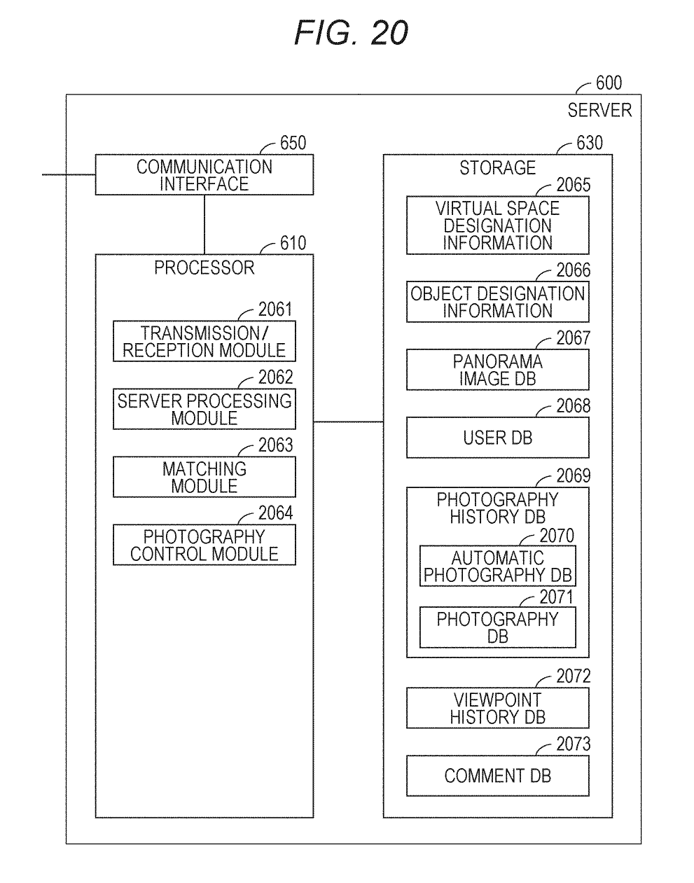

FIG. 20 is a diagram of a hardware configuration and a module configuration of the server 600 according to at least one embodiment of this disclosure. In at least one embodiment, the server 600 includes a communication interface 650, a processor 610, and a storage 630 as hardware.

The communication interface 650 functions as a communication module for wireless communication, which is configured to perform, for example, modulation/demodulation processing for transmitting/receiving signals to/from an external communication device, for example, the computer 200. The communication interface 650 is implemented by, for example, a tuner or a high frequency circuit.

The processor 610 controls operation of the server 600. The processor 610 executes various control programs stored in the storage 630 to function as a transmission/reception module 2061, a server processing module 2062, a matching module 2063, and a photography control module 2064.

The transmission/reception module 2061 transmits and receives various kinds of information to/from each computer 200. For example, the transmission/reception module 2061 transmits to each computer 200 a request that an object be arranged in the virtual space 11, a request that an object be deleted from the virtual space 11, a request that an object be moved, a sound of the user, or information for defining the virtual space 11.

The server processing module 2062 updates, based on information received from the computer 200, a photography history database (DB) 2069, a viewpoint history DB 2072, and a comment DB 2073, which are each described later.

The matching module 2063 performs a series of processing steps for associating a plurality of users. For example, when an input operation for the plurality of users to share the same virtual space 11 is performed, the matching module 2063 performs, for example, processing of associating respective user IDs of those plurality of users belonging to the virtual space 11 with one another.

The photography control module 2064 detects, based on the history (photography history DB 2069, viewpoint history DB 2072, and comment DB 2073) of panorama moving images viewed by the user in the past, the place and timing at which the user expressed an interest in a panorama moving image. The photography control module 2064 transmits the detection result to the computer 200.

The storage 630 stores virtual space designation information 2065, object designation information 2066, a panorama image DB 2067, a user DB 2068, the photography history DB 2069, the viewpoint history DB 2072, and the comment DB 2073.

The virtual space designation information 2065 is information to be used by the virtual space definition module 1427 of the computer 200 to define the virtual space 11. For example, the virtual space designation information 2065 includes information for designating the size or shape of the virtual space 11.

The object designation information 2066 designates an object to be arranged (generated) in the virtual space 11 by the virtual object generation module 1428 of the computer 200. The panorama image DB 2067 stores a plurality of panoramas image 13 to be distributed to the computer 200 and identification information (hereinafter also referred to as “panorama image ID”) for identifying each panorama image 13 in association with each other.

The user DB 2068 contains information (user ID) for identifying each of a plurality of users and attribute information on each user.

The photography history DB 2069 contains information on the photography performed in the virtual space 11. The photography history DB 2069 includes an automatic photography DB 2070 and a photography DB 2071. The automatic photography DB 2070 includes information on, of the photography performed in the virtual space 11, the automatic photography (photography not requiring operation by user 5), which is described later. The photography DB 2071 includes information on, of the photography performed in the virtual space 11, the photography actively performed by the user 5.

The viewpoint history DB 2072 contains information indicating the position in the panorama image 13 viewed by the user. The comment DB 2073 includes comments made by the user regarding the panorama image 13. Some features of the photography history DB 2069, the viewpoint history DB 2072, and the comment DB 2073 are described later.

[Automatic Photography Based on Sound]

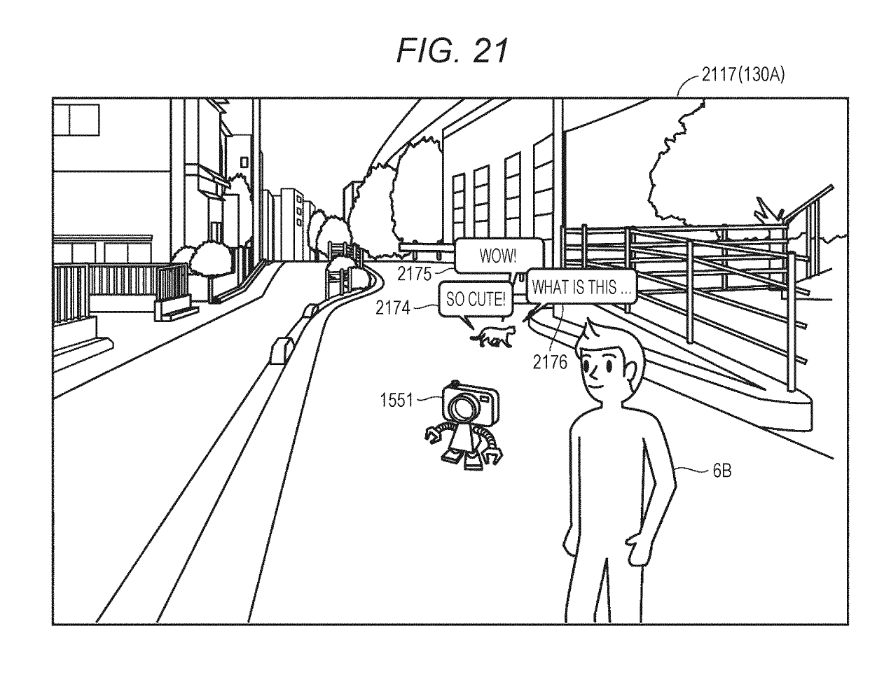

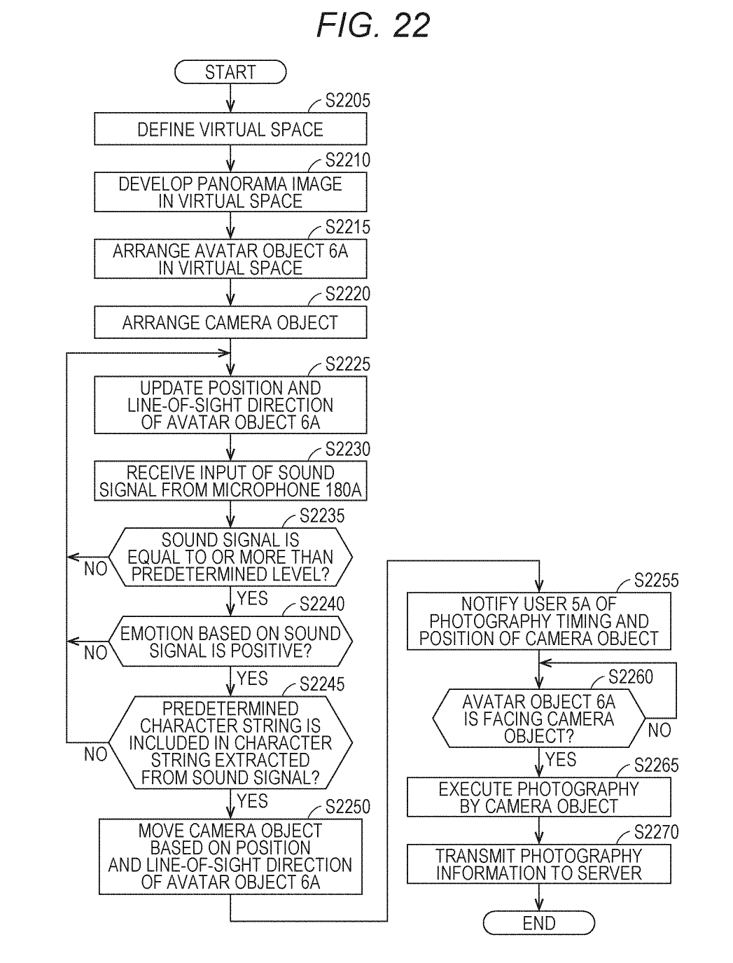

Next, automatic photography processing based on the sound of the user 5A is described with reference to FIG. 21 and FIG. 22. FIG. 21 is a diagram of a field-of-view image 2117 displayed on the monitor 130A according to at least one embodiment of this disclosure. The field-of-view image 2117 includes a portion of the panorama image 13 representing a city scene, an avatar object 6B, the camera object 1551, and comment objects 2174 to 2176. In FIG. 21, the camera object 1551 has a camera shape, but in at least one aspect, the camera object 1551 has a shape other than a camera. In at least one aspect, the camera object 1551 is not visible in the virtual space 11.

The processor 210A serves as a photography control module 1431A to execute automatic photography based on the sound signal of the user 5A input from the microphone 170A. More specifically, the processor 210A executes automatic photography based on at least one of the level (sound volume) of the sound signal, a character string extracted from the sound signal, or an emotion of the user 5 estimated from the sound signal.

(Automatic Photography Based on Sound Volume)

The photography control module 1431A of at least one embodiment detects the photography timing when the level (amplitude) of the sound signal input from the microphone 170A becomes equal to or more than a level determined in advance. The reason for this is because when the user 5A is emitting a loud voice, there is a high possibility that the user 5A is excited by the content developed in the panorama image 13 or by conversation with the user 5B.

(Automatic Photography Based on Uttered Content)

The photography control module 1431A of at least one embodiment extracts a character string from the sound signal input from the microphone 170A. In at least one example, the photography control module 1431A compares waveform data delimited at predetermined time units (e.g., in units of 10 msec) from the start of the sound signal with an acoustic model (not shown) stored in the storage 230A, to extract a character string. The acoustic model represents a feature for each phoneme, such as vowels and consonants. As an example, the processor 210A compares the sound signal with the acoustic model based on the hidden Markov model.

The photography control module 1431A detects the photography timing when a character string determined in advance (e.g., exclamation such as “Wow”, “Oh”, or “Eh”) is included in the extracted character string.

(Automatic Photography Based on Emotion Estimated from Sound Signal)

The emotion determination module 1432A of at least one embodiment estimates an emotion of the user 5A based on the input sound signal. For example, the emotion determination module 1432A extracts a character string from the sound signal, and estimates an emotion from the character string. Such processing may be implemented by, for example, “Emotion Analysis API” provided by Metadata Inc. In at least one aspect, the emotion determination module 1432A estimates an emotion from the waveform of the sound signal. Such processing may be implemented by, for example, “ST Emotion SDK” provided by AGI. Inc.

The emotion determination module 1432A detects the photography timing when the emotion estimated from the sound signal is a positive emotion (e.g., when type of emotion is “happiness” or “enjoyment”).

When photography control module 1431A detects the photography timing based on any one of the methods described above, automatic photography processing by the camera object 1551 is executed. This processing is described more specifically with reference to FIG. 22.

(Control Structure)

FIG. 22 is a flowchart of automatic photography processing based on sound according to at least one embodiment of this disclosure. The processing in FIG. 22 is implemented by the processor 210A reading and executing a control program stored in the memory 220A or the storage 230A.

In Step S2205, the processor 210A serves as the virtual space definition module 1427A to define the virtual space 11A based on the virtual space designation information 2065 received from the server 600.

In Step S2210, the processor 210A serves as the virtual space definition module 1427A to develop the panorama image 13 received from the server 600 in the virtual space 11A. In at least one aspect, the processor 210A is configured to receive a designation of a panorama image ID from the server 600 and to develop in the virtual space 11A a panorama image corresponding to the received ID among the plurality of panorama images 13 stored in the space information 1441A.

In Step S2215, the processor 210A serves as an avatar control module 1430A to arrange the avatar object 6A corresponding to the user 5A in the virtual space 11A.

In Step S2220, the processor 210A serves as the photography control module 1431A to arrange the camera object 1551 in the virtual space 11A. In at least one aspect, the processor 210A arranges the camera object 1551 in the virtual space 11 for the first time when the processing of Step S2250, which is described later, is performed. In this case, the user 5A visually recognizes the camera object 1551 only when the processor 210A performs the automatic photography, and hence the user 5A is able to concentrate on viewing the panorama image 13.

In Step S2225, the processor 210A serves as the avatar control module 1430A to update the position and line-of-sight direction (inclination) of the avatar object 6A. More specifically, the processor 210A updates the line-of-sight direction of the avatar object 6A based on the inclination of the HMD 120A identified by the inclination identification module 1423A. The processor 210A updates the position of the avatar object 6A based on output of the HMD sensor 410A and output of the controller 300A.

In Step S2230, the processor 210A receives input of the sound signal from the microphone 170A.

In Step S2235, the processor 210A serves as the photography control module 1431A to determine whether the sound signal corresponding to the utterance of the user 5A is equal to or more than a level determined in advance (e.g., 70 dB). In response to a determination that the sound signal is equal to or more than the level determined in advance (YES in Step S2235), the processor 210A executes the processing of Step S2240. Otherwise (NO in Step S2235), the processor 210A again executes the processing of Step S2225.

In Step S2240, the processor 210A serves as the emotion determination module 1432A to estimate the emotion of the user 5A based on the input sound signal. The processor 210A determines whether the estimated emotion of the user 5A is positive. In response to a determination that the emotion of the user 5A is positive (YES in Step S2240), the processor 210A executes the processing of Step S2245. In at least one embodiment, a positive emotion includes emotions such as happiness, excitement or the like. Otherwise (NO in Step S2240), the processor 210A again executes the processing of Step S2225.

In Step S2245, the processor 210A extracts a character string from the sound signal corresponding to the utterance of the user 5A, and determines whether a character string determined in advance is included in the extracted character string.

In response to a determination that the character string determined in advance is included in the extracted character string (YES in Step S2245), the processor 210A executes the processing of Step S2250. Otherwise (NO in Step S2245), the processor 210A again executes the processing of Step S2225.

In Step S2250, the processor 210A serves as the photography control module 1431A to move the camera object 1551 based on the position and line-of-sight direction of the avatar object 6A. More specifically, the processor 210A moves the camera object 1551 such that at least a part (e.g., head) of the avatar object 6A is included in the photography range 1552 of the camera object 1551. In at least one example, the processor 210A arranges the camera object 1551 at a position where the photography direction of the camera object 1551 and the line-of-sight direction of the avatar object 6A face each other, e.g., extend in opposite directions.

In Step S2255, the processor 210A serves as the photography control module 1431A to notify the user 5A of the position of the camera object 1551 and that the current timing is suitable for photography.

In at least one example, the processor 210A notifies the user 5A of the photography timing by outputting from the speaker 180A a sound (e.g., “Say cheese!”) indicating that photography is about to be performed. In at least one example, the processor 210A notifies the user 5A of the photography timing by displaying on the monitor 130A a message to the effect that photography is about to be performed (e.g., by counting down time until photography).

In at least one example, the processor 210A notifies the user 5A of the position of the camera object 1551 by arranging the camera object 1551 in the field-of-view region 15A. In at least one example, the processor 210A notifies the user 5A of the position of the camera object 1551 by a sound (e.g., “Face backward”).

In Step S2260, the processor 210A serves as the photography control module 1431A to determine whether the avatar object 6A is facing the camera object 1551. A reference-line-of-sight 16A corresponds to the line-of-sight direction of the avatar object 6A. Therefore, when the reference-line-of-sight 16A is directed at the camera object 1551, the processor 210A determines that the avatar object 6A is facing the camera object 1551.

In response to a determination that the avatar object 6A is facing the camera object 1551 (YES in Step S2260), the processor 210A executes the processing of Step S2265. Otherwise (NO in Step S2260), the processor 210A waits until the avatar object 6A is facing the camera object 1551.

In Step S2265, the processor 210A serves as the photography control module 1431A to execute photography processing by the camera object 1551. More specifically, the processor 210A generates an image corresponding to the photography range 1552 of the camera object 1551.

With the processing described above, the computer 200A automatically generates an image including the avatar object 6A looking at the camera at the timing suitable for photography. Therefore, the user 5A is able to obtain a photograph generated at a timing suitable for photography without actively performing a photography operation.

In at least the example described above, the computer 200A is configured to automatically perform photography when all of the three conditions of Step S2235 to Step S2245 are satisfied. However, in at least one aspect, the computer 200A is configured to automatically perform photography when at least one of the three conditions is satisfied.

In Step S2270, the processor 210A transmits photography information to the server 600. The photography information is information on the photography processing executed in Step S2265. The server 600 updates the automatic photography DB 2070 based on the received photography information.

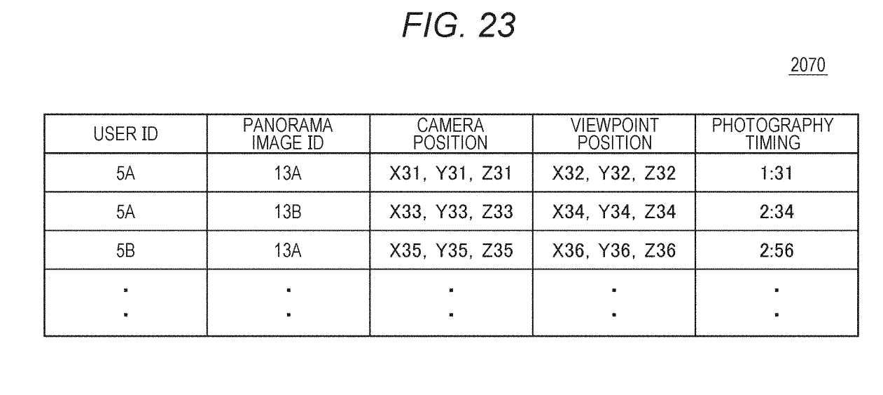

FIG. 23 is a table of the data structure of the automatic photography DB 2070 according to at least one embodiment of this disclosure. The automatic photography DB 2070 stores a user ID, a panorama image ID, a camera position, a viewpoint position, and a photography timing in association with each other.

The photography timing represents, when the panorama image 13 is a moving image, the timing at which photography is performed, based on the start of playback of the panorama image 13 as a start point (Step S2265). The camera position is the position of the camera object 1551 at the photography timing. The viewpoint position is the position of the panorama image 13 at which the line of sight of the user 5 is directed at the photography timing. Each time automatic photography processing is performed, each computer 200 transmits the user ID, the panorama image ID, the camera position, the viewpoint position, and the photography timing to the server 600.

The automatic photography processing described above is performed at a timing at which the user 5A is estimated to have expressed an interest in the content developed in the virtual space 11A. Therefore, the photography timing and the viewpoint position can be said to be the timing and the position at which the content the user is interested in is displayed. The administrator of the server 600 can analyze the preference of the user 5 based on the automatic photography DB 2070 (viewpoint position and photography timing).

(Processing of Generating Image Containing Content User has Expressed Interest in)

In at least the example described above, the photography control module 1431A is configured to arrange the camera object 1551 in the virtual space 11A such that the line-of-sight direction of the avatar object 6A and the photography direction of the camera object 1551 are facing each other (Step S2250).

In this case, the image obtained by the automatic photography processing does not include the content the user 5A has expressed an interest in in the panorama image 13. There are users who not only want their own avatar object to be included, but also want the content the users expressed an interest in to be photographed. Therefore, the photography control module 1431A of at least one embodiment arranges the camera object 1551 in the virtual space 11A such that the content the user 5A has expressed an interest in is also included.

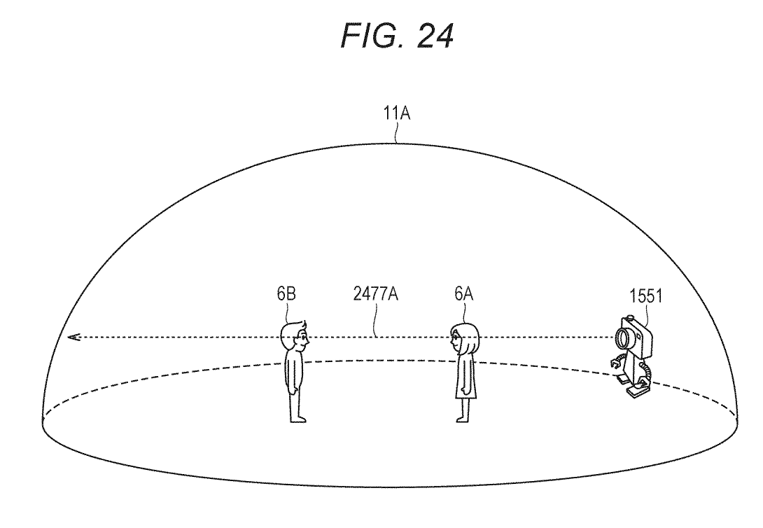

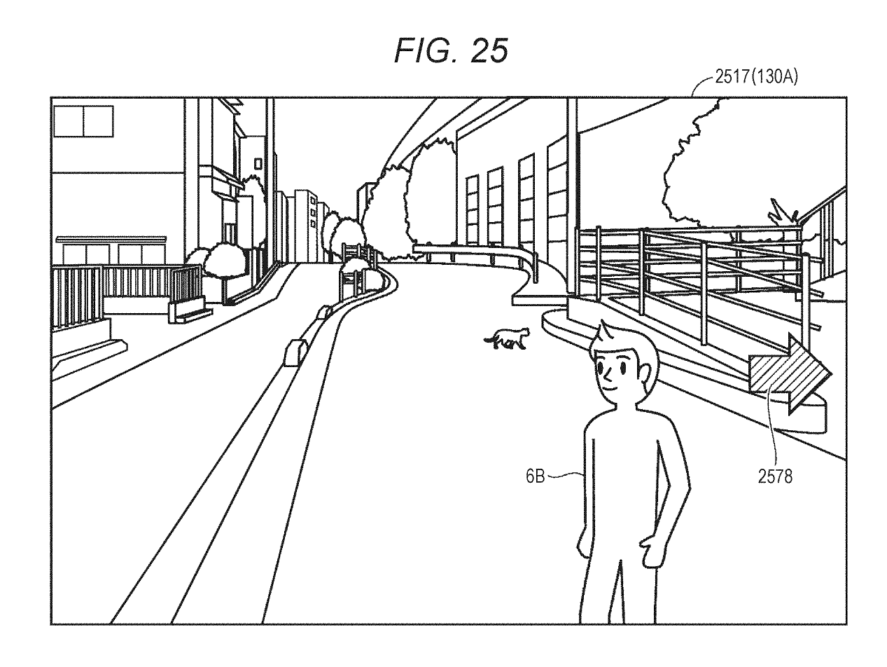

FIG. 24 is a diagram of processing of arranging the camera object 1551 according to at least one embodiment of this disclosure. FIG. 25 is a diagram of a field-of-view image 2517 displayed on the monitor 130A under the state of FIG. 24 according to at least one embodiment of this disclosure. In the virtual space 11A, avatar objects 6A and 6B are arranged. Those avatar objects are facing each other. Under this state, the processor 210A detects the photography timing based on the sound signal of the user 5A output by the microphone 170A.

When the photography timing is detected, the processor 210A arranges the camera object 1551 in the direction opposite to the line-of-sight direction of the avatar object 6A. More specifically, the processor 210A arranges the camera object 1551 on a line extending in the direction opposite to the reference-line-of-sight 16A (photography direction of virtual camera 14A). In other words, the camera object 1551 faces in a same direction as avatar object 6A with avatar object 6A positioned in the field of view of the camera object 1551.

The processor 210A notifies the user 5A of the position of the camera object 1551. In FIG. 25, the processor 210A notifies the position of the camera object 1551 by arranging an arrow icon 2578. The arrow icon 2578 indicates the position of the camera object 1551 with reference to the position and line-of-sight direction of the avatar object 6A in the virtual space 11A.

In at least one aspect, the processor 210A outputs from the speaker 180A a sound (e.g., “Face backward”) to the user 5A notifying that the camera object 1551 is arranged behind the avatar object 6A.

As a result, the user 5A (avatar object 6A) looks backward. The processor 210A generates, when the user 5A looks backward, an image corresponding to the photography range 1552 of the camera object 1551.

This image includes the avatar object 6A looking at the camera and the content (e.g., avatar object 6B) the user 5A was viewing at the photography timing.

With the configuration described above, the computer 200 according to at least one embodiment of this disclosure can automatically generate an image containing the content the user is interested in.

[Automatic Photography Processing Based on Facial Expression]

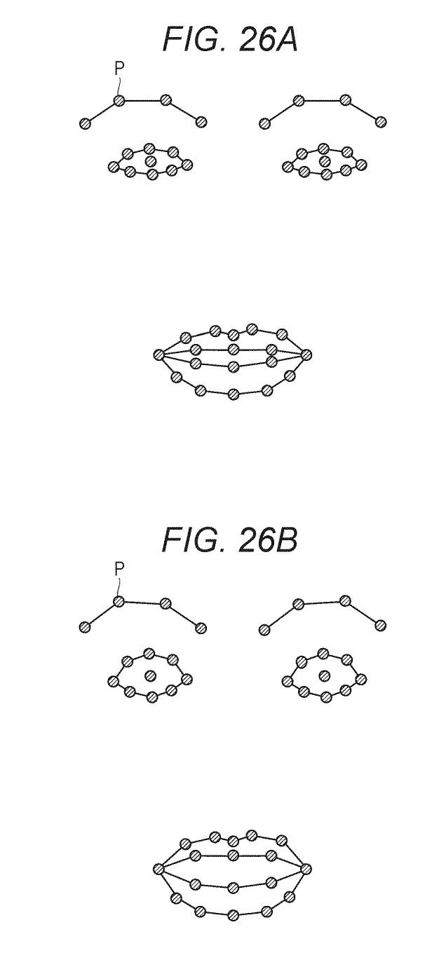

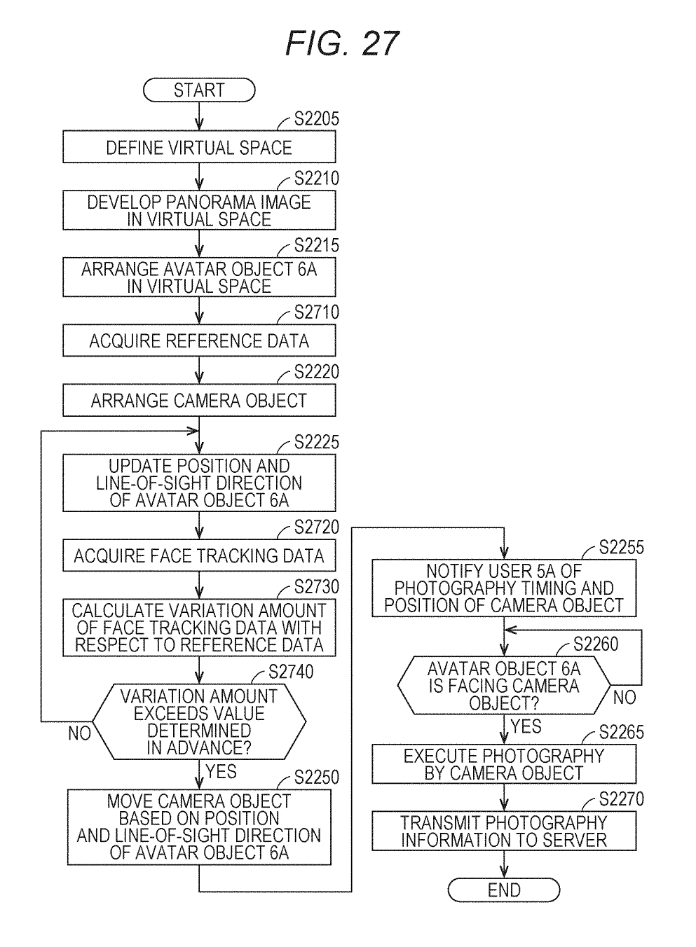

In at least the example described above, the processor 210A is configured to detect the photography timing based on a sound signal. In at least one aspect, the processor 210A detects the photography timing based on face tracking data (facial expression of user 5A). This processing is now described with reference to FIG. 26A, FIG. 26B, and FIG. 27.

FIG. 26A is a diagram of facial feature points acquired when the user 5A has a neutral facial expression according to at least one embodiment of this disclosure. FIG. 26B is a diagram of facial feature points acquired when the user 5A is surprised according to at least one embodiment of this disclosure. Feature points P in FIG. 26A and FIG. 26B represent the feature points of the face of the user 5A acquired by the tracking module 1425A.

In at least one aspect, the processor 210A photographs the face of the user 5A by using a first camera 150A and a second camera 160A. At this time, the processor 210A displays on the monitor 130A a message prompting photography with a neutral expression. The processor 210A generates face tracking data based on the acquired image. The face tracking generated at this time functions as reference data 1448A. The processor 210A stores the generated reference data 1448 in the memory module 530A.

The feature points P in FIG. 26A correspond to the reference data 1448A. Meanwhile, the feature points P of FIG. 26B correspond to face tracking data acquired as required during the period in which the user 5A is immersed in the virtual space 11A.

In FIG. 26B, because the user 5A is surprised, the feature points P of the eyes have become wider in the height direction of the face, and the feature points P of the eyebrows have moved upward. In other words, a variation amount of the face tracking data with respect to the reference data represents a degree of interest by the user 5A in the content.

Therefore, the processor 210A detects that the photography timing has arrived when the variation amount of the face tracking data with respect to the reference data is more than a variation amount determined in advance.

In at least one aspect, the processor 210A calculates the variation amount of the face tracking data with respect to the reference data for each feature point, and performs the above-mentioned determination based on the sum of those variation amounts. In at least one aspect, the processor 210A calculates the variation amounts only for feature points determined in advance (e.g., feature points corresponding to mouth corners) having a large degree of change due to emotion, and performs the above-mentioned determination based on the sum of those variation amounts.

With the configuration described above, the processor 210A can generate an image by automatic photography when the user 5A has expressed an interest in the content.

(Control Structure)

FIG. 27 is a flowchart of automatic photography processing based on face tracking data according to at least one embodiment of this disclosure. Of the processing in FIG. 27, processing that is similar to that described above is denoted with like reference numerals, and a description thereof is omitted here.

In Step S2710, the processor 210A serves as the tracking module 1425A to photograph the face of the user 5A by using the first camera 150A and the second camera 160A. At this time, the processor 210A displays on the monitor 130A a message prompting photography with a neutral facial expression. The processor 210A generates the reference data 1448A based on the acquired image, and stores the generated data in the memory module 530A. In at least one aspect, the processor 210A executes the processing of Step S2710 before displaying the initial field-of-view image 17 on the monitor 130A.

In Step S2720, the processor 210A serves as the tracking module 1425A to acquire face tracking data representing the facial expression of the user 5A.

In Step S2730, the processor 210A serves as the emotion determination module 1432A to calculate the variation amount of the face tracking data with respect to the reference data 1448A.

In Step S2740, the processor 210A determines whether the calculated variation amount exceeds a value determined in advance. In response to a determination that the calculated variation amount exceeds the value determined in advance (YES in Step S2740), the processor 210A executes the processing of Step S2250 and the subsequent steps. Otherwise (NO in Step S2740), the processor 210A again executes the processing of Step S2225.

With the processing described above, the computer 200A according to at least one embodiment can execute automatic photography processing at a timing at which, based on the face tracking data, that the user 5A is estimated to have expressed an interest in the content developed in the virtual space 11A.

[Detection of Photography Timing Based on History of Another User]

In at least the example described above, the computer 200A is configured to perform automatic photography processing based on a motion (utterance or facial expression motion) of the user 5A. In at least one aspect, the server 600 detects, based on history information on the panorama image 13 of one or more other users (e.g., users 5B to 5D) different from the user 5A, the place and timing at which another user expressed an interest in those panorama images 13. The server 600 transmits the detected information to the computer 200A. The computer 200A performs automatic photography processing based on the information received from the server 600.

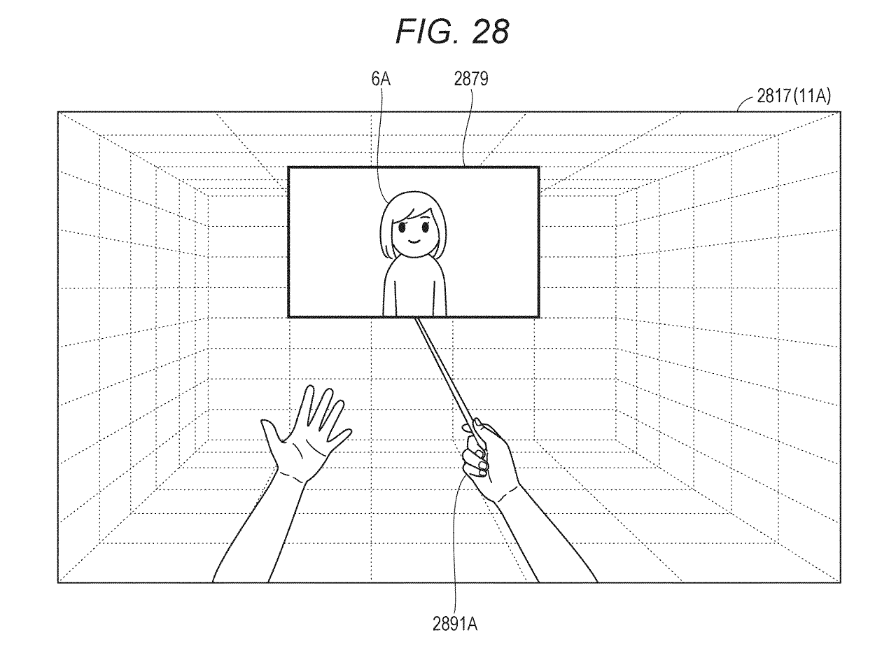

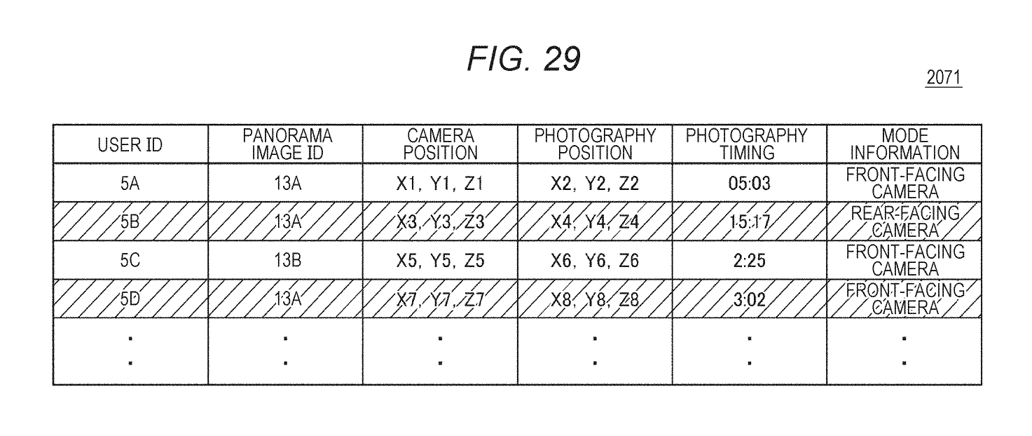

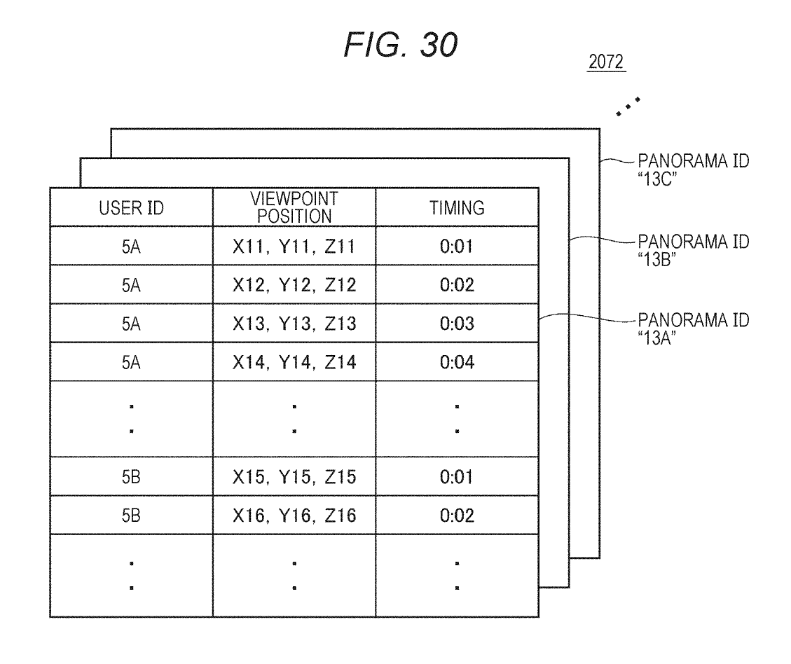

The server 600 uses the database of at least one of the photography history DB 2069, the viewpoint history DB 2072, or the comment DB 2073 to detect the above-mentioned place and timing. First, detection processing based on the photography history DB 2069 (photography DB 2071) is described with reference to FIG. 28 and FIG. 29.

(Automatic Photography Processing Based on Photography History of Another User)

FIG. 28 is a diagram of how the user 5A actively performs photography in the virtual space 11A according to at least one embodiment of this disclosure. Afield-of-view image 2817 includes a hand 2891A of the avatar object 6A and a screen object 2879.

The screen object 2879 has a photography function. In at least one example, the screen object 2879 is a rectangular object having a front surface and a back surface. The front surface functions as a preview screen.

The hand 2891A is holding a stick supporting the screen object 2879. Self-photography sticks (also called selfie sticks or selca (self-camera) sticks) supporting a smartphone (or device having photography function) are known by the public. Therefore, through presenting together the screen object 2879 having a preview screen and the stick-like support member, there is a higher possibility that the user 5A is aware of the photography function of the screen object 2879.

The screen object 2879 is capable of switching between a front-facing camera mode of taking a photograph on the front side and a rear-facing camera mode of taking a photograph on the rear side. In FIG. 28, the screen object 2879 functions in the front-facing camera mode. Therefore, on the front surface (preview screen) of the screen object 2879, the avatar object 6A is displayed. The user 5A executes photography by the screen object 2879 by pressing a button determined in advance of the controller 300A. As a result, the image displayed on the preview screen of the screen object 2879 is stored in the memory module 530A.

When photography is executed by the screen object 2879, the processor 210A transmits photography information on the photography to the server 600. The server 600 updates the photography DB 2071 based on the photography information received from each computer 200.

FIG. 29 is a table of the data structure of the photography DB 2071 according to at least one embodiment of this disclosure. The photography DB 2071 stores a user ID, a panorama image ID, a camera position, a photography position, a photography timing, and mode information in association with each other.

The photography timing is, when the panorama image 13 is a moving image, the timing at which photography is performed, based on the start of playback of the panorama image 13 as a start point. The camera position is the position of the screen object 2879 at the photography timing. The photography position is the position of the panorama image 13 intersected by the photography direction of the screen object 2879 (normal to front surface during front-facing camera mode and normal to rear surface during rear-facing camera mode) at the photography timing. More specifically, the photography position represents, of the panorama image 13, the center of the photographed region. The mode information indicates whether photography is performed in the front-facing camera mode or in the rear-facing camera mode. Each time a user 5 actively performs photography, the computer 200 corresponding to that user transmits the user ID, the panorama image ID, the camera position, the photography position, the photography timing, and the mode information in association with each other.

In at least one aspect, the processor 610 of the server 600 receives from the computer 200A a panorama image ID designating any one of the plurality of panorama images 13 stored in the panorama image DB 2067. There is now described, as an example, a case in which the server 600 receives input of the panorama image ID “13A”.

The processor 610 distributes to the computer 200A the panorama image 13 corresponding to the panorama image ID “13A”. The processor 610 also refers to the photography DB 2071, and acquires, of the photography information associated with the designated panorama image ID “13A”, the photography information not associated with the user ID “5A” of the user 5A. In FIG. 29, the processor 610 obtains information corresponding to the hatched portion.

In at least one aspect, the processor 610 acquires only photography information whose mode information is the front-facing camera mode. An image generated in the front-facing camera mode basically contains the avatar object corresponding to the user. Therefore, in the case of detecting the timing at which an image including an avatar object is automatically generated, the processor 610 may detect a timing more suitable for photography by using only photography information that is in the front-facing camera mode.

The processor 610 serves as the photography control module 2064 to detect the place and the timing at which a user other than the user 5A expressed an interest in the panorama image 13 having the panorama image ID “13A”, based on the photography position and the photography timing of the acquired photography information.

In at least one example, the processor 610 detects the timing and the place (position) photographed a predetermined number of times (e.g., five times) or more within a predetermined time (e.g., 2 seconds) and within a predetermined region (e.g., 100 pixels×100 pixels). In at least one example, photography is performed five times within a predetermined region during a period of from 1 minute and 1 second to 1 minute and 3 seconds after starting playback of the panorama image 13. In this case, the processor 610 detects the timing at the playback time of 1 minute and 2 seconds, which is the middle of the playback time, and the center position of the five photography positions.

The processor 610 transmits to the computer 200A the detected place and timing at which another user expressed an interest. When that timing is reached (playback time of 1 minute and 2 seconds in example described above), the processor 210A of the computer 200A arranges the camera object 1551. At this time, the processor 210A arranges the camera object 1551 such that the place the other user expressed an interest in is included in the photography range 1552. For example, the processor 210A arranges the camera object 1551 at a position where the photography direction of the camera object 1551 and the photography direction of the avatar object 6A face each other.

The processor 210A further notifies the user 5A of the photography timing. Then, the processor 210A executes photography by the camera object 1551.

In at least one aspect, the processor 210A performs the processing of arranging the camera object 1551 and the processing of notifying of the photography timing slightly before (e.g., 5 seconds before) the timing indicated by the information received from the server 600.

With the configuration described above, even when the user 5A does not grasp the timing and position of the panorama image 13 as the photography point, the user 5A is able to reliably acquire a self-photographed image at the photography point.

(Automatic Photography Processing Based on Viewpoint History of Another User)

FIG. 30 is a table of a data structure of the viewpoint history DB 2072 according to at least one embodiment of this disclosure. The viewpoint history DB 2072 includes a panorama image ID, a user ID, a viewpoint position, and a timing.

The viewpoint position represents the position at which the user 5 is looking in the panorama image 13 (i.e., position at which line of sight of user is directed). The timing is, when the panorama image 13 is a moving image, the timing (playback time) at which the viewpoint position is acquired, based on the start of playback of the panorama image 13 as a start point.

In each computer 200, the viewpoint position (coordinate values) identified by the viewpoint identification module 1426, the timing at which the viewpoint position is acquired, and the user ID are periodically (in example of FIG. 30, at one second intervals) transmitted to the server in association with each other. The processor 610 of the server 600 updates the viewpoint history DB 2072 based on the received information.

In at least one aspect, the processor 610 receives input of the panorama image ID “13A” from the computer 200A. The processor 610 refers to the viewpoint history DB 2072, and detects the place and timing at which another user expressed an interest in the panorama image 13 having the panorama image ID “13A” based on the viewpoint position associated with the panorama image ID “13A” and the timing corresponding to the viewpoint position. For example, the processor 610 detects the timing and the place (position) in which the viewpoint position is included a predetermined number of times (e.g., three times) or more within a predetermined time (e.g., 2 seconds) and within a predetermined region (e.g., 100 pixels×100 pixels).

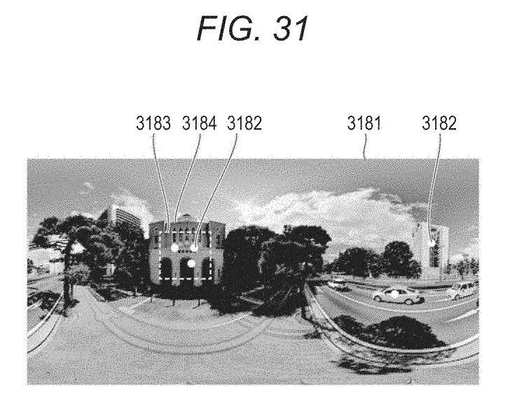

FIG. 31 is a panorama image 3181 for describing automatic photography processing based on viewpoint history according to at least one embodiment of this disclosure. The panorama image 3181 is one of a plurality of panorama images forming the panorama moving image having the panorama image ID “13A”. More specifically, the panorama image 3181 is an image at a certain timing of the panorama moving image having the panorama image ID “13A”.

Viewpoint positions 3182 indicating which part of the panorama image 3181 another user has been looking at are superimposed on the panorama image 3181 of FIG. 31. The viewpoint positions 3182 are superimposed on cars and buildings.

The processor 610 detects that three viewpoint positions 3182 are included in a predetermined area 3183 of the panorama image 3181. As a result, the processor 610 detects the timing at which the panorama image 3181 is played back and the center position of the three viewpoint positions 3182 included in the predetermined area 3183.

The processor 610 transmits to the computer 200A the detected place (position) and timing at which the other user expressed an interest. The subsequent processing is similar to that for the automatic photography processing based on photography history. As a result, the processor 210A of the computer 200A can automatically generate an image including the avatar object 6A and the place (in example of FIG. 31, building 3184) another user expressed an interest in.

(Automatic Photography Processing Based on Comment of Another User)

Referring to FIG. 21, the panorama image 2117 includes the comment objects 2174 to 2176. Each computer 200 receives input of a comment from the user 5 at any timing (in example of FIG. 21, timing at which panorama image 2117 is displayed) and position in the panorama moving image. Each computer 200 transmits to the server 600 the input comment and, based on the start of playback of panorama moving image as a start point, the timing (posting timing) at which the comment is posted and the position at which the comment is posted (comment position). The processor 610 of the server 600 updates the comment DB 2073 based on the information received from each computer 200.

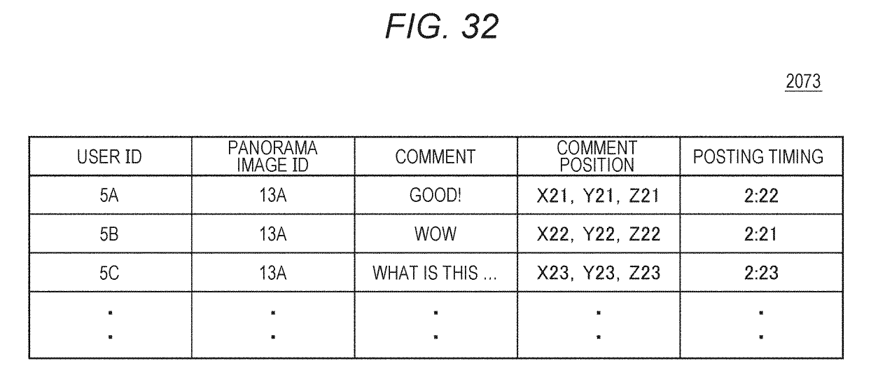

FIG. 32 is a table of a data structure of the comment DB 2073 according to at least one embodiment of this disclosure. The comment DB 2073 stores a user ID, a panorama image ID, a comment, a comment position, and a posting timing in association with each other.

In at least one aspect, the processor 610 receives input of the panorama image ID “13A” from the computer 200A. In response to this, the processor 610 refers to the comment DB 2073, and transmits to the computer 200A the comment, the comment position, and the posting timing associated with the panorama image ID “13A”. When the posting timing is reached, the processor 210A arranges a comment object including the comment content at the comment position. In this way, the user 5A is able to visually recognize the comment of another user.

The processor 610 refers to the comment history DB 2073, and detects the place and timing at which another user expressed an interest in the panorama image 13 having the panorama image ID “13A” based on the comment position associated with the panorama image ID “13A” and the posting timing. The processor 610 refers to the comment history DB 2073, and detects the timing and the place (position) in which the comment position is included a predetermined number of times (e.g., three times) or more within a predetermined time (e.g., 2 seconds) and within a predetermined region (e.g., 100 pixels×100 pixels).

The processor 610 transmits to the computer 200A the detected place (position) and timing at which the other user expressed an interest. The subsequent processing is the same as that for the automatic photography processing based on photography history. As a result, the processor 210A of the computer 200A is able to generate, based on the comment history of the other user, an image including the place (in example of FIG. 21, place in which cat is displayed) in which the other user expressed an interest and the avatar object 6A.

(Control Structure)

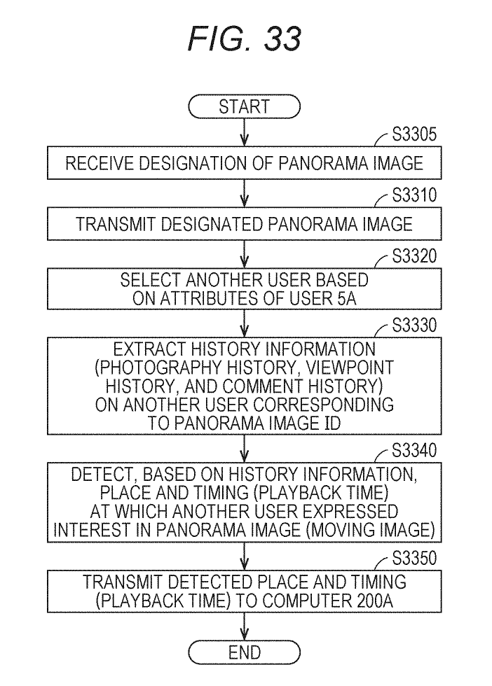

FIG. 33 is a schematic flowchart of processing in which the server 600 detects the photography timing according to at least one embodiment of this disclosure. In Step S3305, the processor 610 of the server 600 receives a designation of a panorama image from the computer 200A. In at least one example, the processor 610 receives a designation of a panorama image ID from the computer 200A.

In Step S3310, the processor 610 distributes to the computer 200A the panorama image corresponding to the input panorama image ID.

In Step S3320, the processor 610 refers to the user DB 2068, and selects one or more other users other than the user 5A based on attributes of the user 5A.

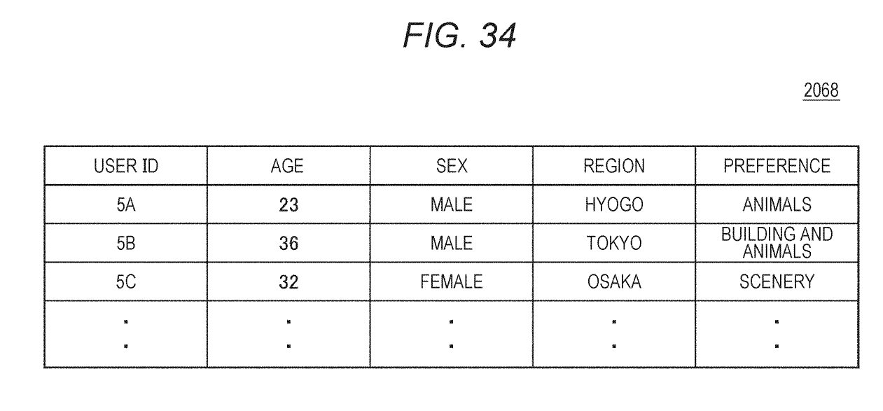

FIG. 34 is a table of a data structure of the user DB 2068 according to at least one embodiment of this disclosure. The user DB 2068 includes a user ID, age, sex, region, and preference. The processor 610 selects another user (user ID) having attributes close to the attributes of the user 5A (in example of FIG. 34, age, sex, region, and preference). For example, the processor 610 selects a user of the same sex as the user 5A and having an age difference from the age of the user 5A of less than 5 years.

Referring again to FIG. 33, in Step S3330, the processor 610 extracts history information on the panorama moving image having the designated panorama image ID of the selected other user. For example, the history information includes the photography position and photography timing at which another user performed photography in the virtual space in which the panorama moving image is developed. In at least one example, the history information includes the viewpoint position of another user in the panorama moving image and the timing corresponding to the viewpoint position. In at least one example, the history information includes the comment position and the posting timing of comments posted by another user regarding the panorama moving image.

In Step S3340, the processor 610 detects, based on the history information, the place and timing at which another user expressed an interest in the panorama moving image. The processor 610 serves as the photography control module 2064 to execute the processing of Step S3320 to Step S3340.

In Step S3350, the processor 610 transmits the detected place and timing to the computer 200A. The processor 210A of the computer 200A arranges, based on the information received from the server 600, the camera object 1551 such that the place the other user expressed an interest is included in the photography range 1552. The processor 210A notifies the user 5A of the timing at which the other user expressed an interest. Then, the processor 210A executes photography by the camera object 1551.

With the processing described above, the HMD system 100 according to at least one embodiment can automatically generate, based on history information on another user, an image including the place the another user expressed an interest.

The server 600 detects a photography point based on the history of the other user having attributes close to the user 5A. As a result, the HMD system 100 can increase the likelihood that the user 5A likes the image generated by automatic photography.

In at least one aspect, the server 600 is configured to transmit the history information on the other user to the computer 200A, and the computer 200A is configured to detect the place and timing at which the other user expressed an interest based on the history information. As an example, the server 600 transmits the history information extracted in Step S3330 to the computer 200A, and the computer 200A executes the processing of Step S3340 based on the received history information.

[Processing of Automatically Generating Image Including Avatar of Another User]

In at least the example described above, the computer 200A is configured to automatically generate an image including the avatar object 6A corresponding to the user 5A of the computer 200A. In at least one aspect, the user 5A communicates to/from another user 5 in the virtual space 11A. In this case, the user 5A may want not only an image including his or her own avatar object 6A but also an image including the avatar object corresponding to the another user 5 to be automatically generated. Therefore, there is now described processing of automatically generating an image including the avatar object of another user.

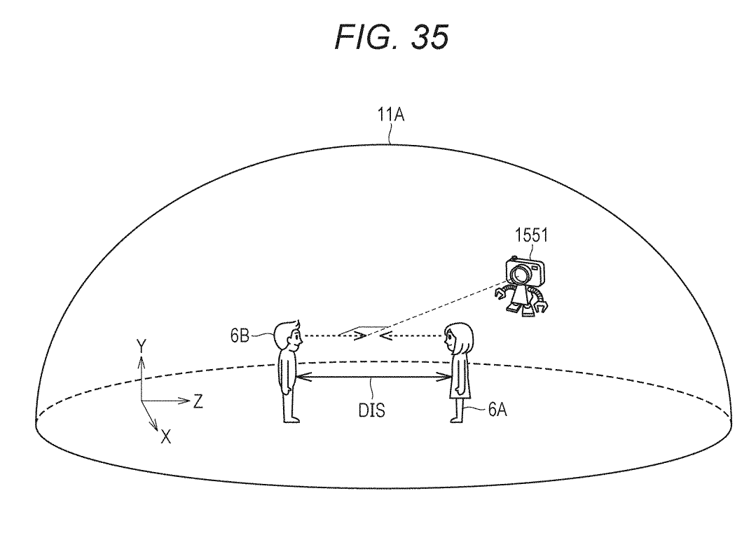

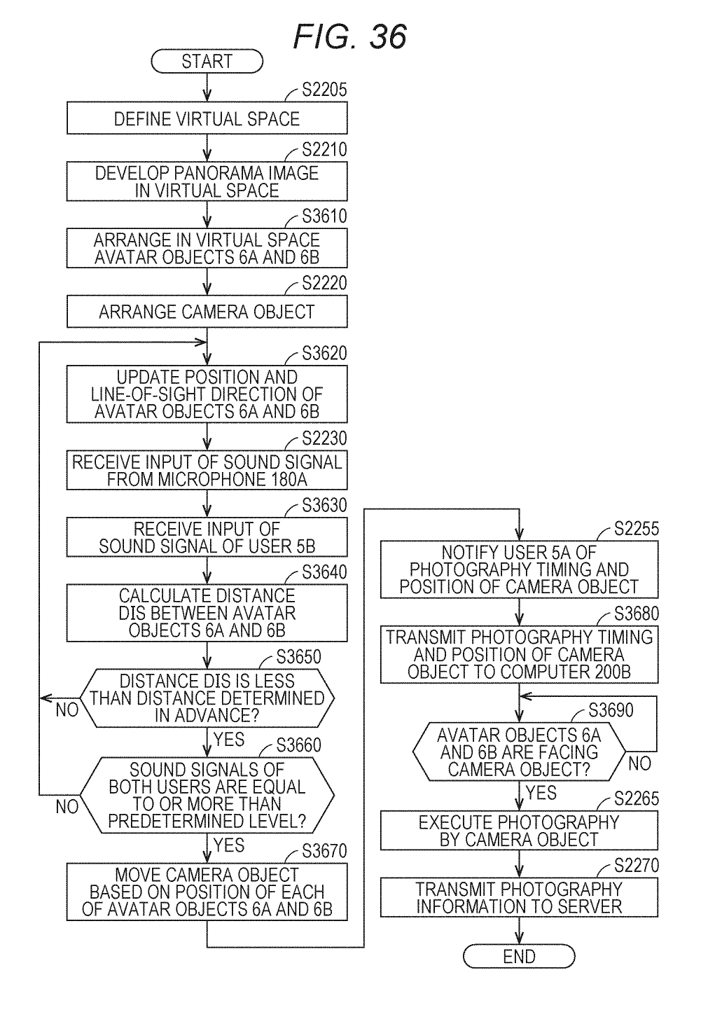

FIG. 35 is a diagram of processing of generating an image including an avatar object of another user according to at least one embodiment of this disclosure. Referring to FIG. 35, the avatar object 6A and the avatar object 6B are arranged in the virtual space 11A under a state in which the avatar object 6A and the avatar object 6B are separated by a distance DIS. The user 5A communicates to/from the user 5B corresponding to the avatar object 6B in the virtual space 11A.

The computer 200A automatically generates an image including at least a portion (e.g., head) of each of the avatar objects at a timing the user 5A and the user 5B are estimated to be excited. As an example, the processor 210A of the computer 200A executes automatic photography triggered by the sound signal corresponding to the user 5A and the sound signal corresponding to the user 5B. For example, the processor 210A executes automatic photography when both sound signals are equal to or more than a level determined in advance. In at least one example, the processor 210A executes automatic photography based on the face tracking data of each of the users 5A and 5B.

In at least one aspect, the processor 210A executes automatic photography when the distance DIS by which both of the avatar objects are separated is less than a predetermined distance (e.g., 100 pixels) and the above-mentioned condition is satisfied. This is because there is a higher possibility that the users 5A and 5B are communicating in the virtual space in such a case. There is now described, at least one example of automatic photography processing based on the sound signals of both the users 5A and 5B with reference to FIG. 36.

(Control Structure)

FIG. 36 is a flowchart of processing of automatically generating an image including the avatar object 6B under a state in which the processor 210A is communicating to/from the computer 200 according to at least one embodiment of this disclosure. Of the processing in FIG. 36, processing that is similar to that described above is denoted with like reference numerals, and a description thereof is omitted here.

In Step S3610, the processor 210A arranges in the virtual space 11A the avatar object 6A corresponding to the user 5A. The processor 210A further arranges, based on information (e.g., modeling data) received from the computer 200B, the avatar object 6B corresponding to the user 5B in the virtual space 11A.

In Step S3620, the processor 210A updates the position and line-of-sight direction (inclination) of the avatar object 6A. The processor 210A further receives from the computer 200B inclination information on the HMD 120B identified by the inclination identification module 1423B and position information on the avatar object 6B. The processor 210A then updates the position and line-of-sight direction of the avatar object 6B based on the received information.

In Step S3630, the processor 210A receives from the computer 200B input of the sound signal of the user 5B acquired by the microphone 170B.

In Step S3640, the processor 210A calculates the distance DIS between the avatar objects 6A and 6B. Specifically, the processor 210A calculates the distance DIS based on the position of the avatar object 6A and the position of the avatar object 6B.

In Step S3650, the processor 210A determines whether the calculated distance DIS is less than a distance determined in advance (e.g., 100 pixels). In response to a determination that the distance DIS is less than the distance determined in advance (YES in Step S3650), the processor 210A executes the processing of Step S3660. Otherwise (NO in Step S3650), the processor 210A again executes the processing of Step S3620.

In Step S3660, the processor 210A determines whether the sound signal of the user 5A and the sound signal of the user 5B are both equal to or more than a level determined in advance (e.g., 70 dB). In response to a determination that the sound signals of both users are equal to or more than the level determined in advance (YES in Step S3660), the processor 210A executes the processing of Step S3670. Otherwise (NO in Step S3660), the processor 210A again executes the processing of Step S3620.

In Step S3670, the processor 210A serves as the photography control module 1431A to move the camera object 1551 based on the position and line-of-sight direction of each of the avatar objects 6A and 6B. Specifically, the processor 21 OA moves the camera object 1551 such that the avatar objects 6A and 6B are included in the photography range 1552 of the camera object 1551. In at least one example, the processor 210A moves the camera object 1551 such that the distance between the avatar object 6A and the camera object 1551 and the distance between the avatar object 6B and the camera object 1551 are equal.

In at least one aspect, the processor 210A does not execute the processing of Step S2220, and arranges the camera object 1551 in the virtual space 11A at the time of the processing of Step S3670.

In Step S2255, the processor 210A notifies the user 5A of the position of the camera object 1551 and that the current timing is suitable for photography. As a result, the user 5A sees the camera object 1551 in the virtual space 11A.

In Step S3680, the processor 210A transmits to the computer 200B the photography timing notified in Step S2255 and the position of the camera object 1551. The computer 200B notifies the user 5B of the photography timing and the position of the camera object 1551, and the user 5B sees the camera object 1551 in the virtual space 11B. As a result, the line-of-sight direction (and position) of the avatar object 6B in the virtual space 11B are updated. The computer 200B transmits the updated line-of-sight direction (and position) of the avatar object 6B to the computer 200A.

In Step S3690, the processor 210A determines whether the avatar objects 6A and 6B are facing the camera object 1551. In response to a determination using the determination method described above that the line of sight (reference-line-of-sight) of each of the avatar objects 6A and 6B is directed at the camera object 1551 (YES in Step S3690), the processor 210A executes the processing of Step S2265. Otherwise (NO in Step S3690), the processor 210A waits until the line of sight of each of the avatar objects 6A and 6B is directed at the camera object 1551.

With the processing described above, when the computer 200A estimates based on the sound signals of the users 5A and 5B that both users are excited, the computer 200A can automatically generate an image including the avatar objects of both users. The computer 200A may automatically generate an image in which both of the avatar objects are looking at the camera. As a result, the user 5A can communicate to/from the user 5B more smoothly by discussing an automatically generated image as a topic.

[Configurations]

The technical features disclosed above are summarized in the following manner.

(Configuration 1) According to at least one embodiment of this disclosure, there is provided a method to be executed by a computer 200A configured to provide a virtual space 11A by an HMD 120. This method executed by the computer 200A includes defining the virtual space 11A (Step S2205). The method further includes arranging an avatar object 6A corresponding to a user 5A of an HMD 120A in the virtual space 11A (Step S2215). The method further includes arranging a camera object 1551 having a photography function in the virtual space 11A such that at least a portion of the avatar object 6A is included in a photography range of the camera object 1551 (Step S2250). The method further includes notifying the user 5A of a timing suitable for photography in the virtual space 11A and a position of the camera object 1551 (Step S2255). The method further includes generating an image corresponding to the photography range 1552 of the camera object 1551 after the notification (Step S2265).

(Configuration 2) The method of Configuration 1 further includes receiving input of a sound signal corresponding to an utterance of the user 5A (Step S2230). The notifying includes notifying the user 5A of the timing based on the sound signal.

(Configuration 3) In Configuration 2, the notifying includes notifying the user 5A of the photography timing when a level of the sound signal is equal to or more than a level determined in advance (Step S1935).

(Configuration 4) In Configuration 2 or 3, the notifying includes: extracting a character string from the sound signal; and notifying the user 5A of the timing when the extracted character string includes a character string determined in advance (Step S2245).

(Configuration 5) The method according to any one of Configurations 2 to 4 further includes arranging an avatar object 6B corresponding to a user 5B of a computer 200B capable of communicating to/from the computer 200A (Step S3610). The method further includes receiving input of a sound signal corresponding to the user 5B of the computer 200B (Step S3630). The arranging of the camera object 1551 in the virtual space 11A includes arranging the camera object 1551 in the virtual space 11A such that at least a portion of each of the avatar objects 6A and 6B is included in the photography range 1552 of the camera object 1551 (Step S3670). The notifying includes: notifying the user 5A of the timing based on the sound signal of the user 5A and the sound signal of the user 5B (Step S3660); and transmitting to the computer 200B information indicating the timing and information indicating the position of the camera object 1551 (Step S3680).

(Configuration 6) The method according to Configuration 5 further includes calculating a distance DIS between the avatar object 6A and the avatar object 6B (Step S3640). The notifying includes notifying, when the calculated distance DIS is less than a distance determined in advance, the user 5A of the timing based on the sound signal of each of the users 5A and 5B (Step S3650).

(Configuration 7) In Configuration 5 or 6, the notifying includes notifying the user 5A of the timing (Step S3660) when the sound signal of each of the users 5A and 5B exceeds a level determined in advance.

(Configuration 8) The method according to any one of Configurations 1 to 7 further includes receiving input of face tracking data representing a facial expression of the user 5A (Step S2720). The notifying includes notifying the user 5A of the timing based on the face tracking data (Step S2730 to Step S2740).

(Configuration 9) The method according to Configuration 8 further includes receiving input of reference data to be used for a comparison with the face tracking data (Step S2710). The notifying of the user 5A of the photography timing based on the face tracking data includes notifying the user 5A of the timing when a variation amount of the face tracking data with respect to the reference data exceeds a variation amount determined in advance (Step S2740).

(Configuration 10) The method according to any one of Configurations 1 to 9 further includes developing a panorama moving image in the virtual space 11A (Step S2210). The method further includes receiving from the server 600 input of history information (history information extracted in Step S3330) on the panorama moving image of one or more other users different from the user 5A. The method further includes detecting, based on the history information, a place of interest and a timing of interest at which another user expressed an interest in the panorama moving image. The notifying includes notifying the user 5A of the timing of interest. The arranging of the camera object 1551 in the virtual space 11A includes arranging the camera object 1551 such that the place of interest is included in the photography range of the camera object 1551.

(Configuration 11) In Configuration 10, the receiving of the input of the history information includes receiving input of history information on another user selected by the server 600 based on a user DB 2068 and having an attribute close to an attribute of the user 5A.

(Configuration 12) In Configuration 10 or 11, the history information includes a photography timing and a photography position at a time when another user performed photography in the virtual space 11A in which the panorama moving image is developed. The server 600 refers to a photography DB 2071 to extract those pieces of information. The detecting includes detecting a place of interest and a timing of interest based on the photography timing and the photography position.

(Configuration 13) In any one of Configurations 10 to 12, the history information includes a viewpoint position in the panorama moving image of each of a plurality of other users and a timing corresponding to the viewpoint position. The server 600 refers to a viewpoint history DB 2072 to extract those pieces of information. The detecting includes detecting a place of interest and a timing of interest based on the viewpoint position and the timing corresponding to the viewpoint position.

(Configuration 14) In any one of Configurations 10 to 13, the history information includes a posting timing at which each of a plurality of other users posted a comment in the panorama moving image and a comment position in which the comment is to be arranged. The server 600 refers to a comment history DB 2073 to extract those pieces of information. The detecting includes detecting a place of interest and a timing of interest based on the posting timing and the comment position.

(Configuration 15) The method according to Configurations 1 to 9 further includes developing a panorama moving image in the virtual space 11A (Step S2210). The method further includes receiving from the server 600 input of a place of interest and a timing of interest at which an interest is expressed in the panorama moving image by one or more other users different from the user 5A (receiving of the information transmitted by the server 600 in Step S3350). The notifying includes notifying the user 5A of the timing of interest that has been received. The arranging of the camera object 1551 in the virtual space 11A includes arranging the camera object 1551 such that the place of interest is included in the photography range 1552 of the camera object 1551.

(Configuration 16) In Configurations 1 to 15, the notifying the user 5A of the position of the camera object 1551 includes notifying the user audibly or visually. For example, the method includes outputting a sound from a speaker 180A informing the user 5A of the position of the camera object 1551. This sound is a message (e.g., “face right”) directly informing the user 5A of the position of the camera object 1551. In at least one aspect, the sound indirectly informs the user 5A of the position of the camera object 1551 by a stereo sound in which right and left outputs are adjusted (e.g., outputting of sound “face this way” from only right output of speaker 180A).

(Configuration 17) In any one of Configurations 1 to 16, the generating of the image includes generating an image based on detection that the avatar object 6A is facing the camera object 1551 (Step S2260).

One of ordinary skill in the art would understand that the embodiments disclosed herein are merely examples in all aspects and in no way intended to limit this disclosure. The scope of this disclosure is defined by the appended claims and not by the above description, and this disclosure encompasses all modifications made within the scope and spirit equivalent to those of the appended claims.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted the target object based on motion of the hand of the user.

1-13. (canceled)

14. A method comprising:
defining a first virtual space comprising a first avatar and a virtual viewpoint, wherein the first avatar is associated with a first user and the first user is associated with a first head-mounted device (HMD), and the virtual viewpoint defines a first field of view;
detecting in a real space a motion of a part of a body of the first user;
controlling the first avatar in the virtual space in response to the detected motion of the part of the body;
arranging a camera object in the first field of view, wherein the camera object defines a second field of view comprising at least a portion of the first avatar;
detecting whether a photography event has occurred in the virtual space;
notifying, in response to the occurrence of the photography event, the first user that a photographed image corresponding to the second field of view is to be generated; and
generating the photographed image after the notification.

15. The method according to claim 14, further comprising:
receiving input of a sound signal, wherein the sound signal corresponds to a detected utterance by the first user; and
detecting that the photography event has occurred in response to a volume of the sound signal being equal to or more than a threshold value.

16. The method according to claim 14, further comprising:
receiving input of a sound signal, wherein the sound signal corresponds to a detected utterance by the first user;
extracting a character string from the sound signal; and
detecting that the photography event has occurred in response to the extracted character string including a predefined character string.

17. The method according to claim 14,
wherein the first virtual space further comprises a second avatar, the second avatar being associated with a second user,
wherein the second field of view comprises at least a portion of the second avatar, and
wherein the method further comprises:
detecting in the real space a motion of a part of a body of the second user;
controlling the second avatar in accordance with the detected motion of the part of the body of the second user;
notifying, in response to detection of the photography event, the second user that a photographed image corresponding to the second field of view is to be generated; and
generating the photographed image after the notification.

18. The method according to claim 17, further comprising:
receiving input of a first sound signal, wherein the sound first signal corresponds to a detected utterance by the first user; receiving input of a second sound signal, wherein the second sound signal corresponds to a detected utterance by the second user; and
detecting that the photography event has occurred in response to a volume of the first sound signal being equal to or more than a threshold value or the volume of the second sound signal being equal to or more than the threshold value.

19. The method according to claim 18, further comprising:
calculating a distance in the virtual space between the first avatar and the second avatar; and
detecting that the photography event has occurred in response to the calculated distance being less than a predefined distance.

20. The method according to claim 14, further comprising:
detecting a shape of a part of a face of the first user in the real space;
calculating a displacement amount of the detected shape of the part of the face with respect to a reference shape; and
detecting that the photography event has occurred in response to the calculated displacement amount exceeding a threshold value.

21. The method according to claim 14, further comprising:
associating the virtual space with the first user;
playing back a panorama moving image in the virtual space;
associating a second virtual space with a second user different from the first user, wherein the second virtual space is different from the virtual space;
playing back the panorama moving image in the second virtual space;
acquiring a behavior history of the second user in the second virtual space;
identifying, in accordance with the acquired behavior history, a scene in which the second user expressed an interest in the panorama moving image; and
detecting that the photography event has occurred in response to the arrival of the scene during the playback timing of the panorama moving image.

22. The method according to claim 21, further comprising:
comparing first attribute information indicating an attribute of the first user with second attribute information indicating an attribute of the second user; and
informing, in accordance with the attribute of the first user matching to the attribute of the second user, that the panorama moving image is to be played back in the second virtual space.

23. The method according to claim 21, further comprising:
identifying a playback timing at which the photographed image is generated, wherein the photographed image is generated during the playback of the panorama moving image in the second virtual space; and
identifying the scene based on the playback timing.

24. The method according to claim 21, further comprising:
identifying a history of movement of a viewpoint executed by the second user during the playback of the panorama moving image in the second virtual space;
identifying, based on the movement history, a target on which the second user focused; and
identifying the scene based on the identified target.

25. The method according to claim 21, further comprising:
identifying a comment posted by the second user during the playback of the panorama moving image in the second virtual space;
identifying a playback timing of the panorama moving image with which the comment is associated; and
identifying the scene based on the identified playback timing.

26. The method according to claim 14, further comprising:
identifying a line of sight of the first avatar; and
generating the photographed image in response to the line of sight being directed at the camera object.

27. A method comprising:
defining a virtual space, wherein the virtual space comprises at least one avatar, each avatar of the at least one avatar is associated with a corresponding user, and each avatar of the at least one avatar has a virtual viewpoint;
receiving an input from at least one user;
detecting a line of sight of the at least one user in response to the received input;
arranging a camera object in the virtual space based on the detected line of sight, wherein the camera object defines a field of view including an avatar associated with the at least one user;
notifying the at least one user that a photography event will happen in response to the received input exceeding a threshold value; and
photographing the field of view in response to the detected line of sight intersecting with the camera object after the notification.

28. The method according to claim 27, wherein the receiving of the input comprises receiving an utterance from the at least one user, and
the notifying the at least one user comprises notifying the at least one user in response to a detected volume of the utterance exceeding the threshold value.

29. The method according to claim 27, wherein the receiving of the input comprises detecting a part of a face of the at least one user, and
the notifying the at least one user comprises notifying the at least one user in response to a difference between the detected part of the face of the at least one user and a predefined reference image exceeding the threshold value.

30. The method according to claim 27, wherein the at least one avatar comprises a first avatar and a second avatar, and
the notifying the at least one user comprises notifying both a first user associated with the first avatar and a second user associated with the second avatar.

31. The method according to claim 27, further comprising:
playing back a panorama moving image to define the virtual space;
detecting a time period during the play back of the panorama moving image at which the received input from the at least one user exceeding the threshold value; and
notifying a second user, different from the at least one user, that the photography event will occur in response to the playing back of the panorama reaching the time period.

32. A system comprising:
a non-transitory computer readable medium configured to store instructions; and
a processor connected to the non-transitory computer readable medium, wherein the processor is configured to execute the instructions for:
defining a first virtual space comprising a first avatar and a virtual viewpoint, wherein the first avatar is associated with a first user, and the virtual viewpoint defines a first field of view;
detecting in a real space a motion of a part of a body of the first user;
controlling the first avatar in the virtual space in response to the detected motion of the part of the body;
arranging a camera object in the first field of view, wherein the camera object defines a second field of view comprising at least a portion of the first avatar;
detecting whether a photography event has occurred in the virtual space;
notifying, in response to the occurrence of the photography event, the first user that a photographed image corresponding to the second field of view is to be generated; and
generating the photographed image after the notification.

33. The system according to claim 32, further comprising a head mounted display (HMD) connected to the processor, wherein the HMD is configured to display the virtual space to the first user.
